(19) United States
(12) Patent Application Publication
(10) Pub. No.: US 2025/0103678 A1
(43) Pub. Date: Mar. 27, 2025

(54) ITERATIVE HYBRID MATRIX MULTIPLIER

(71) Applicant: SYNTHARA AG, Zurich (CH)

(72) Inventors: Avinash GUTTA, Bengaluru (IN); Manu Vijayagopalan NAIR, Zurich (CH)

(21) Appl. No.: 18/832,834

(22) PCT Filed: Jan. 25, 2022
(86) PCT No.: PCT/IB2022/050635

§ 371 Date: Jul. 24, 2024

(51) Int. Cl. G06F 17/16; G06F 7/498

(52) U.S. Cl. CPC G06F 17/16; G06F 7/4983

(57) ABSTRACT

A hybrid time-shared iterative multiply-accumulate circuit comprises a product storage circuit, a multiply circuit operable to receive a first input value, receive a second input value, produce a product of the first input value and the second input value, and store the product in the product storage circuit, an accumulator storage circuit for storing an accumulated value, and an accumulation switch connecting the product storage circuit to the accumulator storage circuit that is operable to electrically connect the product storage circuit and the accumulator storage circuit in parallel or to electrically disconnect the product storage circuit from the accumulator storage circuit.

### TECHNICAL FIELD

The present disclosure relates generally to processing architectures, devices, and methods for matrix multiplication and, in particular to hybrid multiply-accumulate circuits.

### BACKGROUND

Matrix multiplication is an important operation in many mathematical computations. For example, linear algebra can employ matrix multiplication to solves systems of linear equations such as differential equations. Such mathematical computations are applied, for example, in pattern matching, artificial intelligence, analytic geometry, engineering, physics, natural sciences, computer science, computer animation, and economics.

Matrix multiplication is typically performed in digital computers executing stored programs. The programs describe the operations to be performed and hardware in the computer, for example digital multipliers and adders perform the operations. In some computing systems, specially designed hardware can accelerate the rate of computation. In some applications, real-time processing is necessary to provide useful output in useful amounts of time, especially for safety-critical tasks. Moreover, applications in portable devices have only limited power available. Despite such accelerated computing systems, problems with large matrices and high data rates can take longer to solve and use more power than desired. There is a need therefore, for computing hardware accelerators that can perform matrix multiplication at higher rates and with less power.

### SUMMARY

Embodiments of the present disclosure can provide, inter alia, hybrid computing hardware accelerators for performing matrix multiplication using multiply accumulate operations. Computing hardware accelerators of the present disclosure comprises digital binary single-bit multipliers with an analog accumulator. The data values for the single-bit multipliers are each stored in a digital memory and the single-bit multiplication results are stored as a charge in a capacitor. The capacitor charges are combined to sum (accumulate) the values and thus provide a multiply-accumulate operation. By combining capacitor charges, the summation operation is nearly instantaneous, relying on the rate at which charges in a conductor can flow and requiring no external power. Thus, embodiments of the present disclosure can provide a very high speed and low power multiply-accumulate circuit. Because charge is notated as Q in electronic systems, each single-bit multiply-accumulate circuit is referred to as a qmac herein and is a hybrid circuit using digital multiplication and analog accumulation.

According to embodiments of the present disclosure, a hybrid multiply-accumulate circuit comprises an array of single-bit multiply-accumulate circuits, each single-bit multiply accumulate circuit comprising (i) a first storage element for storing a first single-bit value, (ii) a second storage element for storing a second single-bit value, (iii) a bit-multiply circuit for multiplying the first single-bit value times the second single-bit value to calculate a product, and (iv) an analog storage circuit, wherein the bit-multiply circuit is operable to deposit a charge in the analog storage circuit representative of the product. The array of single-bit multiply-accumulate circuits are together operable to combine the charges deposited in each analog storage circuit to provide an accumulated charge representative of a sum of the products. The analog storage circuit can be a capacitor.

According to some embodiments, the hybrid multiply-accumulate circuit comprises a switch circuit connected to the bit-multiply circuit and to the analog storage circuit operable in a first mode to transfer charge from the bit-multiply circuit to the analog storage circuit and operable in a second mode to isolate the bit-multiply circuit from the analog storage circuit and connect the analog storage circuits in the array together to provide the accumulated charge. Some embodiments comprise a clear circuit connected to the analog storage circuits of the array operable remove charge from the analog storage circuits in the array. In some embodiments, the bit-multiply circuit is a functional AND gate or performs the function of an AND gate.

In some embodiments of the present disclosure, the hybrid multiply-accumulate circuit comprises an analog-to-digital converter to convert the accumulated charge connected to the analog storage circuits in the array to a digital accumulated value. Some embodiments comprise a shift circuit or a shift electrical connection to multiply the digital accumulated value by a power of two. Some embodiments comprise a digital adder operable to add the digital accumulated values to produce a digital matrix value. The digital adder can be pipelined

In some embodiments an analog-to-digital converter to convert the output of the analog storage circuits 16 of the parallel-connected qmacs 10 is not present and the addition of the output of the array of hybrid multiply-accumulate circuits is performed by an analog adder operable to add the accumulated charges to produce an analog matrix value. Some embodiments comprise a voltage multiplier connected to the analog storage circuits in the array to multiply the accumulated charges by a power of two. Such an addition and multiplication can be performed by an operational amplifier configured as an adder with op amp inputs connected to the analog storage circuits operable to provide the analog matrix value. The op amp inputs of the operational amplifier can be configured to multiply or divide the op amp inputs by a power of two. Some embodiments comprise an analog-to digital converter to convert the analog matrix value to produce a digital matrix value, so that the output of the op amp is digitized.

In some embodiments, the bit-multiply circuit comprises serially connected switches, for example serial switch circuits comprising pairs of MOS transistors, a first MOS transistor controlled by a positive control signal and a second MOS transistors controlled by an inverted (negative) version of the same control signal. One of the serially connected switches can be controlled by a weight value and another by an input value representing a matrix multiplication of weight values and input values.

According to embodiments of the present disclosure, a hybrid matrix multiplier comprises digital storage elements, each of the digital storage elements operable to store a digital value, a multiply circuit for multiplying the stored digital values to produce a product, and an analog storage circuit operable to store the product. A voltage connection can provide power to operate the digital storage elements, the multiply circuit, and the analog storage circuit. In some embodiments, a power connection provides power to operate the digital storage elements, the multiply circuit, and the analog storage circuit and has a voltage no greater than one V (e.g., no greater 500 mV, no greater than 100 mV, no greater than 50 mV, or no greater than 10 mV). The multiply circuit can comprises serially connected switches comprising pairs of MOS transistors.

According to embodiments of the present disclosure a hybrid time-shared multiply-accumulate circuit comprises a product storage circuit, a multiply circuit operable to receive a first input value, receive a second input value, produce a product of the first input value and the second input value, and store the product in the product storage circuit, an accumulator storage circuit for storing an accumulated value, and an accumulation switch connecting the product storage circuit to the accumulator storage circuit that is operable to electrically connect the product storage circuit and the accumulator storage circuit in parallel or to electrically disconnect the product storage circuit from the accumulator storage circuit.

Some embodiments of the time-shared multiply-accumulate circuit comprise a first multiplexer operable to select one of multiple first input values input to the first multiplexer and wherein the multiply circuit is operable to receive the selected one of the multiple first input values from the first multiplexer, receive the second input value, and produce a product of the selected one of the multiple first input values and the second input value. Some embodiments comprise a second multiplexer operable to select one of multiple second input values input to the second multiplexer and wherein the multiply circuit is operable to receive the selected one of the second input values from the second multiplexer and produce a product of the selected one of the multiple first input values and the selected one of the second input values.

According to some embodiments of the present disclosure, the product storage circuit and the accumulator storage circuit are analog storage circuits that store charge. The product storage circuit and the accumulator storage circuit can be capacitors.

According to some embodiments of the present disclosure, the multiply circuit is a single-bit-multiply circuit for multiplying two binary bits. The multiply circuit can comprise serially connected serial switch circuits. The accumulation switch can be a serial switch circuit serially connected with the serial switch circuits of the multiply circuit. The multiply circuit can comprise serially connected serial switch circuits, and one or more of the serial switch circuits of the multiply circuit and of the accumulation switch can be differential switches.

According to some embodiments of the present disclosure, operating the accumulation switch to connect the product storage circuit and the accumulator storage circuit in parallel combines the accumulated value in the accumulator storage circuit with the product in the product storage circuit to provide a combined value stored in the product storage circuit and in the accumulator storage circuit.

Some embodiments of a hybrid time-shared matrix multiplier comprise a control circuit operable to sequentially (i) provide a first input value and a second input value to the multiplier and switch the accumulation switch to store the product in the product storage circuit and (ii) switch the accumulation switch to electrically connect the product storage circuit and the accumulator storage circuit in parallel and combine the product in the product storage circuit with the accumulated value to provide a combined value stored in the product storage circuit and in the accumulator storage circuit.

According to embodiments of the present disclosure, a hybrid matrix multiplier comprises multiple time-shared multiply-accumulate circuits and an adder for adding the accumulated values of the multiple time-shared multiply-accumulate circuits. The accumulated values can be analog values and some embodiments can comprise an analog-to-digital converter for converting the accumulated values to digital values and the adder can be a digital adder. In some embodiments, the accumulated values are analog values and the adder is an analog adder.

According to embodiments of the present disclosure, a hybrid method of matrix multiplication comprises:
a) providing a multi-bit value having N bits;
b) providing a hybrid time-shared iterative multiply-accumulate circuit;
c) providing an input bit of the multi-bit value, providing a second input bit to the multiplier, and setting the accumulation switch to connect the product storage circuit to the time-shared multiply accumulate circuit and disconnect the product storage circuit from the accumulator storage circuit;
d) multiplying the input bit of the multi-bit value times the second input bit to form a bit product stored in the product storage circuit;
e) switching the accumulation switch to disconnect the product storage circuit from the time-shared multiply accumulate circuit and connect the product storage circuit to the accumulator storage circuit and combine the product in the product storage circuit with the accumulated value to produce a combined value in the accumulator storage circuit; and
f) repeating steps c)-e) N times until all bits of the multi-bit value are provided in bit order to produce a product of the multi-bit value and the second input bit.

According to embodiments of the present disclosure, a hybrid method of matrix multiplication comprises:
a) providing a first multi-bit value having N bits and a second multi-bit value having M bits;
b) providing M time-shared multiply-accumulate circuits of claim 1;
c) providing an input bit of the first multi-bit value and providing a different second input bit of the second multi-bit value to the multiplier of each of the M time-shared multiply-accumulate circuits, and setting the accumulation switch to connect the product storage circuit to the time-shared multiply accumulate circuit and disconnect the product storage circuit from the accumulator storage circuit of each of the M time-shared multiply-accumulate circuits;
d) multiplying the input bit of the multi-bit value times the second input bit to form a bit product stored in the product storage circuit with each of the M time-shared multiply-accumulate circuits;
e) switching the accumulation switch to disconnect the product storage circuit from the time-shared multiply accumulate circuit and connect the product storage circuit to the accumulator storage circuit and combine the product in the product storage circuit with the accumulated value to produce a combined value in the accumulator storage circuit of each of the M time-shared multiply-accumulate circuits;
f) repeating steps c)-e) for each of the N bits of the first multi-bit value until all bits of the first multi-bit value are provided in bit order;
g) scaling the accumulated value of each of the M time-shared multiply-accumulate circuits; and
h) adding the accumulated value of each of the M scaled time-shared multiply-accumulate circuits to produce a product.

According to embodiments of the present disclosure, a hybrid method of matrix multiplication comprises:
a) providing a first multi-bit value having N bits and a second multi-bit value having M bits;
b) providing a time-shared multiply-accumulate circuit of claim 1;
c) providing an input bit of the first multi-bit value and providing a second input bit of the second multi-bit value to the multiplier, and setting the accumulation switch to connect the product storage circuit to the time-shared multiply accumulate circuit and disconnect the product storage circuit from the accumulator storage circuit of the time-shared multiply-accumulate circuit;
d) multiplying the input bit of the first multi-bit value times the second input bit of the second multi-bit value to form a bit product stored in the product storage circuit;
e) switching the accumulation switch to disconnect the product storage circuit from the time-shared multiply accumulate circuit and connect the product storage circuit to the accumulator storage circuit and combine the product in the product storage circuit with the accumulated value to produce a combined value in the accumulator storage circuit of each of the M time-shared multiply-accumulate circuits;
f) repeating steps c)-e) for each of the N bits of the first multi-bit value until all bits of the first multi-bit value are provided in bit order;
g) scaling the accumulated value of the time-shared multiply-accumulate circuit to produce a scaled value;
h) adding the scaled value to a multi-bit product; and
i) repeating steps c)-h) to produce a multi-bit product.

According to embodiments of the present disclosure, a hybrid matrix multiplier comprises a hybrid time-shared iterative multiply-accumulate circuit, a memory circuit for storing an accumulated value, and a control circuit operable to:
a) repeatedly and sequentially (i) provide a first input value and provide a second input value to the multiplier, set the accumulation switch to connect the product storage circuit to the multiplier and disconnect the product storage circuit from the accumulator storage circuit and (ii) switch the accumulation switch to electrically disconnect the product storage circuit from the time-shared multiply accumulate circuit and electrically connect the product storage circuit to the accumulator storage circuit to combine the product in the product storage circuit with the accumulated value and provide a combined value stored in the accumulator storage circuit and the product storage circuit; and
b) store the accumulated value in a memory circuit.

Some embodiments of the present disclosure comprise memory circuits, each memory circuit for storing an accumulated value, and an adder for adding the accumulated values in the memory circuits. The control circuit can be operable to provide different first input values and provide different second input values and store an accumulated value in each memory circuit.

According to some embodiments of the present disclosure, a time-shared multiply-accumulate circuit comprises a multiply circuit operable to receive a first input value, receive a second input value, and produce a product of the first input value and the second input value, an accumulating digital storage circuit operable to store an accumulated digital value, and a digital bit accumulator operable to receive the product, combine the product with the accumulated digital value stored in the accumulating digital storage circuit, and output the accumulated digital value. Combining the product with the accumulated digital value can comprise (i) storing a value in the accumulating digital storage circuit if the product is one and the accumulated digital value is zero, (ii) keeping the same accumulated digital value if the product is one and the accumulated digital value is non-zero, or (iii) or scaling the accumulated digital value by two if the product is zero. Some embodiments of the present disclosure comprise a product storage circuit operable to receive the product and a one-bit analog-to-digital converter connected to the product storage circuit and to the digital bit accumulator. The product storage circuit is operable to provide the product to the one-bit analog-to-digital converter and the one-bit analog-to-digital converter is operable to receive the product, convert the product to a digital bit product, and provide the digital bit product to the digital bit accumulator.

Embodiments of the present disclosure provide fast, efficient, low-power, and small hybrid hardware accelerators that perform matrix multiplication using multiply accumulate operations.

### BRIEF DESCRIPTION OF THE DRAWINGS

The foregoing and other objects, aspects, features, and advantages of the present disclosure will become more apparent and better understood by referring to the following description taken in conjunction with the accompanying drawings, in which:

FIGS. 1A and 1B mathematically illustrate matrix multiplication operations useful in understanding embodiments of the present disclosure;

FIGS. 1C and 1D illustrate matrix multiplication operations with simplified computer-programs useful in understanding embodiments of the present disclosure;

FIG. 2 is a functional schematic of a single-bit multiply-accumulate circuit according to illustrative embodiments of the present disclosure;

FIG. 3 is a schematic of a one-dimensional array of single-bit multiply accumulate circuits shown in FIG. 2 according to illustrative embodiments of the present disclosure;

FIG. 4A is a functional schematic of a single-bit multiply-accumulate circuit with a switch circuit and a clear circuit according to illustrative embodiments of the present disclosure;

FIG. 4B is an abstraction of the functional schematic of FIG. 4A according to illustrative embodiments of the present disclosure;

FIG. 4C is a timing diagram for operating the single-bit multiply-accumulate circuit of FIG. 4A according to illustrative embodiments of the present disclosure;

FIG. 5 is a schematic of a one-dimensional array of single-bit multiply accumulate circuits shown in FIG. 4A according to illustrative embodiments of the present disclosure;

FIG. 6 graphically illustrates a multiplication operation with multiply-accumulate values useful in understanding embodiments of the present disclosure;

FIG. 7 is a schematic of a two-dimensional array of single-bit multiply-accumulate circuits with a digital summation circuit according to illustrative embodiments of the present disclosure;

FIG. 8 is a schematic of a two-dimensional array of single-bit multiply-accumulate circuits with an analog summation circuit according to illustrative embodiments of the present disclosure;

FIGS. 9-10 are schematics of analog summation circuits according to illustrative embodiments of the present disclosure;

FIG. 11A is a schematic of a vector matrix hybrid multiply-accumulate circuit and FIG. 11B illustrates the matrix values in the vector matrix hybrid multiply-accumulate circuit of FIG. 11A according to illustrative embodiments of the present disclosure;

FIG. 12 is a schematic of a vector matrix hybrid multiply-accumulate circuit comprising a two-dimensional array of single-bit multiply-accumulate circuits with an analog summation circuit as shown in FIG. 8 according to illustrative embodiments of the present disclosure;

FIG. 13 is an abstract schematic of cascaded switches controlled with analog voltages demonstrating low-power single-bit multiplication according to illustrative embodiments of the present disclosure;

FIG. 14 is a schematic of a switch controlled with low-power analog voltages according to illustrative embodiments of the present disclosure;

FIG. 15A is a schematic of a time-shared iterative multiply accumulate switch with an accumulating capacitor according to illustrative embodiments of the present disclosure;

FIG. 15B is a schematic of a time-shared iterative multiply accumulate switch with a product storage capacitor and a digital accumulator according to illustrative embodiments of the present disclosure;

FIG. 15C is a schematic of a time-shared iterative multiply accumulate switch with a digital accumulator according to illustrative embodiments of the present disclosure;

FIG. 16 is a schematic of a time-shared iterative multiply accumulate switch with a controller and input multiplexer according to illustrative embodiments of the present disclosure;

FIG. 17 is a flow graph of methods according to illustrative embodiments of the present disclosure;

FIG. 18 is a schematic of multiple time-shared multiply accumulate switches with an analog adder according to illustrative embodiments of the present disclosure;

FIG. 19 is a schematic of multiple time-shared multiply accumulate switches with a digital adder according to illustrative embodiments of the present disclosure;

FIG. 20 is a schematic of a time-shared iterative multiply accumulate switch with a controller and two input multiplexers according to illustrative embodiments of the present disclosure;

FIG. 21 is a flow graph of methods according to illustrative embodiments of the present disclosure;

FIG. 22 is a schematic of a time-shared iterative single-bit multiply accumulate switch for multi-bit multiplication and a digital shift accumulator according to illustrative embodiments of the present disclosure;

FIG. 23 is a schematic of a time-shared single-bit iterative multiply accumulate switch for multi-bit multiplication with analog storage and an analog adder according to illustrative embodiments of the present disclosure;

FIG. 24 is a schematic of a time-shared single-bit multiply accumulate switch for multi-bit multiplication with digital storage and a digital adder according to illustrative embodiments of the present disclosure;

FIG. 25 is a table illustrating time-shared multiplication accumulation for two-bit values according to illustrative embodiments of the present disclosure; and

FIGS. 26A and 26B are tables illustrating time-shared multiplication accumulation for four-bit values according to illustrative embodiments of the present disclosure.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The figures are not necessarily drawn to scale.

### DETAILED DESCRIPTION OF CERTAIN EMBODIMENTS

Certain embodiments of the present disclosure are directed towards single-bit hybrid multiply-accumulate circuits (each a qmac) comprising two digital single-bit binary storage elements that each store a single-bit value, a multiplier to multiply the two single-bit values to compute a product, and an analog charge storage element, such as a capacitor, for storing the product as a charge (or voltage). One dimensional arrays of qmacs can compute and sum a one-dimensional array (a vector) of single-bit products. Two dimensional arrays of qmacs can compute a product for two multi-bit digital multiplicands. (A multiplicand is a value to be multiplied by another to calculate a multiplied product.) The size of the two-dimensional array of qmacs for computing a multi-bit multiplicand can be N+M−1 where N is the number of bits in one of the two digital multiplicands and M is the number of bits in the other of the two digital multiplicands. A vector matrix multiplication and accumulation for two linear vectors (one-dimensional arrays of numbers) with M values can be computed with M two-dimensional arrays and accumulated as a single value.

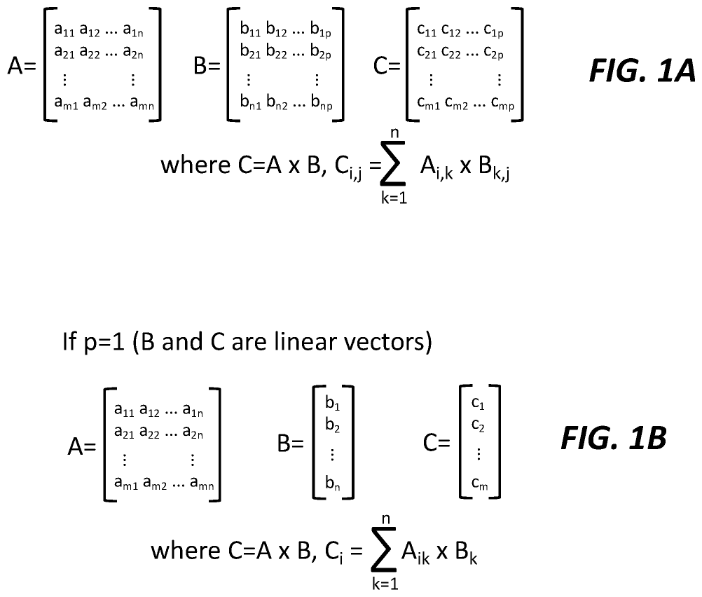

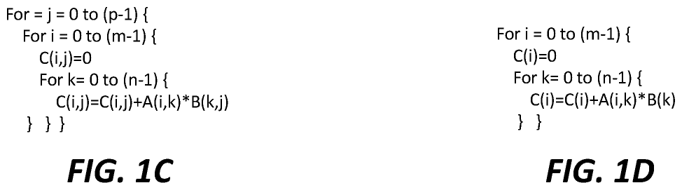

As shown in FIG. 1A, the computation C=A×B where A, B, and C are matrices is a matrix multiplication. If A is an m×n matrix, B is an n×p matrix, then C is an m×p matrix where Cᵢⱼ=ΣAᵢₖ Bₖⱼ for k=1 to n, i=1 to m, and j=1 to p. The summation operation for products of A and B for k=1 to N is a multiply-accumulate (mac) operation. Thus, a matrix multiplication is a series of (i×j) multiply-accumulate operations of size k, each multiply-accumulate operation providing one value of matrix C. FIG. 1B illustrates the computation C=A×B where p=1 so that C and B are linear (e.g. one dimensional or vector) matrices. FIG. 1C is a simplified software program illustrating the computation of the matrix computation of FIG. 1A and FIG. 1D is a simplified software program illustrating the computation of the matrix computation of FIG. 1D. The “For k=0 to (n−1)” loop is a multiply-accumulate operation requiring n multiplications and n additions.

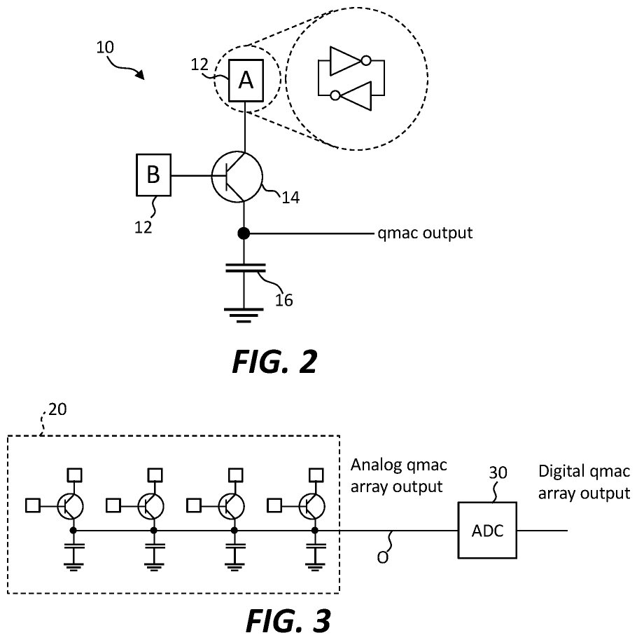

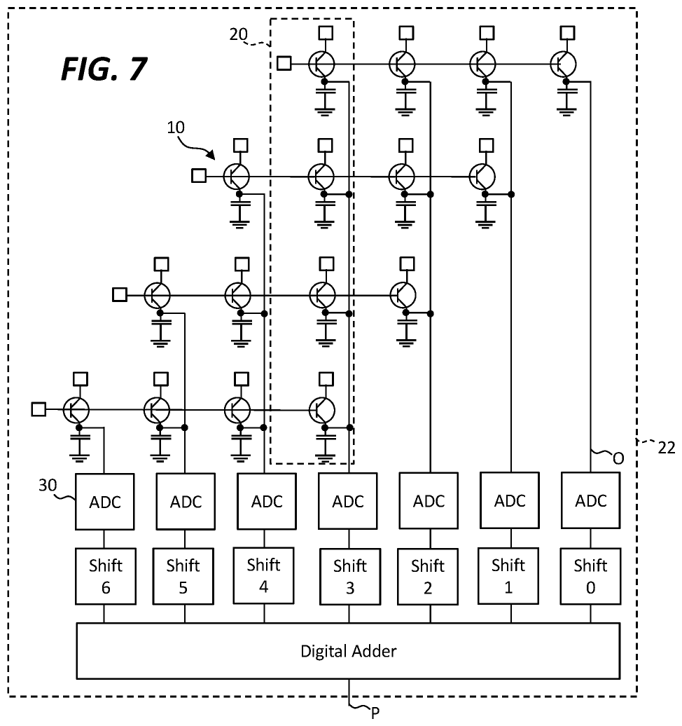

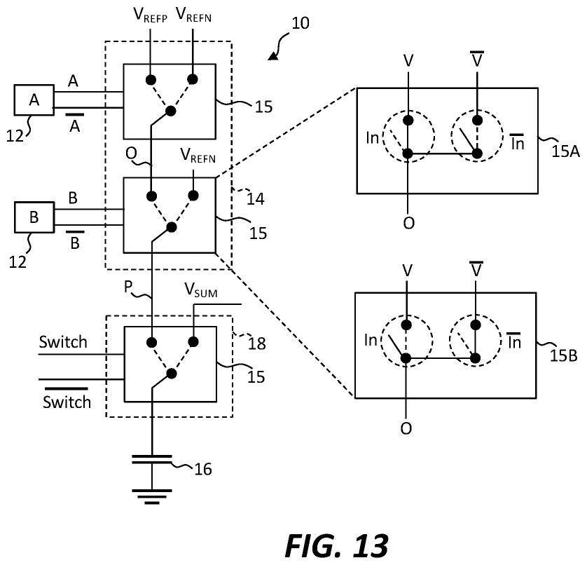

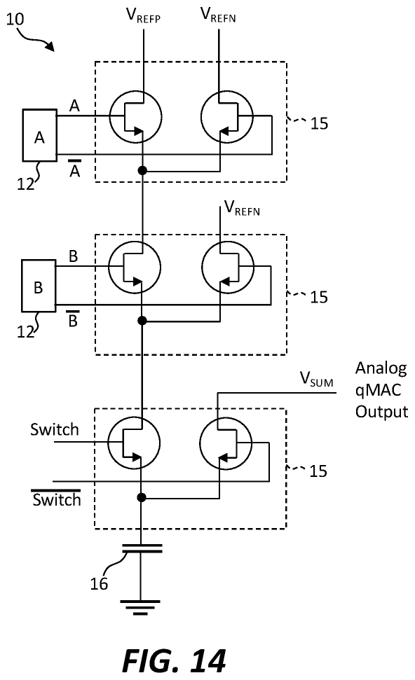

According to embodiments of the present disclosure and as shown in FIGS. 2 and 3, a hybrid multiply-accumulate operation can be performed by an array of qmacs 10, where each qmac 10 comprises a first digital, single-bit binary storage element 12 for storing a first bit A, a second digital, single-bit binary storage element 12 for storing a second bit B, a bit multiplier 14 (a bit-multiply circuit 14) for multiplying multiplicands A and B, producing a product that is stored as a charge in bit capacitor 16 (analog storage circuit 16). In some embodiments storage element 12 is an SRAM cell, a DRAM cell, a flip-flop (e.g., a D flip-flop), or a pair of invertors connected with input to output, as shown in the FIG. 2 inset. In some embodiments, bit multiplier 14 is an AND gate providing a positive value (e.g., one) only when both A and B are positive (e.g., one), thus providing a multiplication. AND gates, as shown in FIG. 2, can be implemented as a transistor with a source connected to the storage element 12 for A and a gate connected to the storage element 12 for B (or vice versa) that provides charge Q stored in bit capacitor 16 when the product of multiplicands A and B is a one value. If a value of A or B is the same for different qmacs 10, the storage element 12 for the constant can be shared by multiple qmacs 10 (e.g., a single storage element 12 can provide an input value to multiple qmacs 10, as shown in FIG. 7 discussed below). As will be appreciated by those knowledgeable in analog and digital circuit design, FIGS. 2 and 3 are simplified designs and much more complex designs are included as embodiments of the present disclosure, such as those illustrated in FIGS. 13 and 14 discussed below that can operate at very low voltages and power. For example, the amount of current deposited on bit capacitor 16 can be very small to reduce the power used by qmac 10 and increase the circuit speed. Bit capacitor 16 can be very small, to reduce the area of bit capacitor 16 in an integrated circuit embodiment. Thus, in some embodiments, bit multiplier 14 very precisely controls the current depositing charge on bit capacitor 16 over time to maintain the accuracy and precision of the multiply-accumulate operation. Thus, bit multiplier 14 can be designed to very precisely control the amount of charge deposited on bit capacitor 16, for example responsive to a carefully calibrated timing signal and voltage.

FIG. 3 illustrates four qmacs 10 with bit capacitors 16 (analog storage circuits 16) connected in parallel to sum the four products in a hybrid multiply-accumulate circuit 20. The four parallel qmacs 10 provide a multiply accumulate operation for four single-bit A values each multiplied by a single-bit B value. The single-bit B values can be the same, or different. Thus, FIG. 3 illustrates a circuit for performing a multiply accumulate operation for four single-bit, binary values (e.g., where k=4 in the mathematical illustration of FIGS. 1A-1D). Thus, the array of single-bit multiply-accumulate circuits 10 are together operable to combine the charges deposited in each analog storage circuit 16 to provide an accumulated charge representative of a sum of the products of the qmacs 10.

The total charge on the parallel-connected bit capacitors 16 provide an analog accumulated value output O that can be converted to a digital value with an analog-to-digital converter (ADC) 30 or used as an analog value for further computations. The absolute value of the voltage or charge (output O) must be scaled by the number of capacitors n because the parallel capacitors have a capacitance equal to the sum of the capacitance of the parallel-connected capacitors. Since the charge on a capacitor is equal to the voltage times the capacitance (Q=CV), if the capacitance increases for a fixed charge the voltage will correspondingly decrease. For example, if every capacitor stores a charge Q equivalent to a one value, the sum of the values will be four (in the illustration of FIG. 3) but the voltage will remain one because the four capacitors are electrically connected in parallel. Thus, the voltage output must be scaled by the number of capacitors (e.g., a factor of four in the illustration of FIG. 3).

Hybrid multiply-accumulate circuits can require less power than a digital equivalent, e.g., using digital adders. The net current or charge leakage from small bit capacitors 16 can be very small and the analog storage circuits 16 and other analog operations can operate at a very low voltage, for example no greater than 1 volt (e.g., no greater than 500 mV, no greater than 100 mV, no greater than 50 mV, or no greater than 10 mV) and lower than a voltage used for conventional digital logic (e.g., 5V, 3.6 V, 3.3 V, or 1.65 V). Some embodiments of the present disclosure can operate at substantially 10 mV.

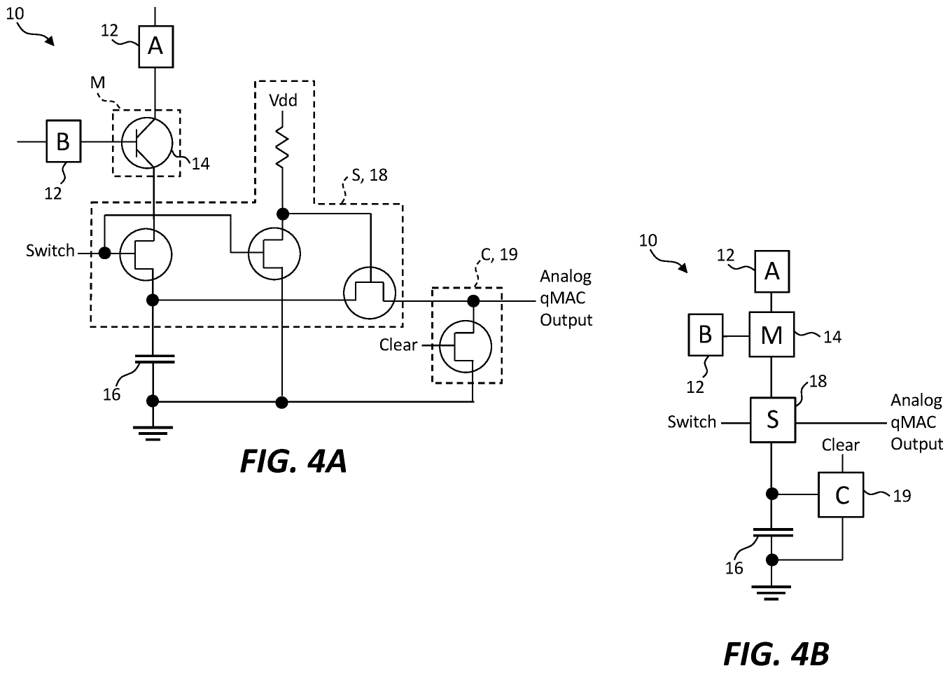

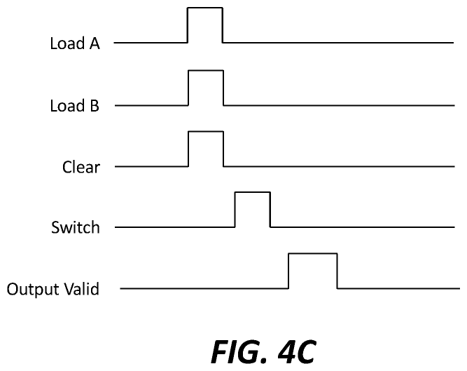

The FIGS. 2 and 3 circuits are a simplified representation of qmacs 10 and their implementation in a multiply-accumulate array. As noted, precise control of charge deposition on bit capacitors 16 helps to maintain multiply-accumulate accuracy and precision. As illustrated in FIG. 4A, a more complex circuit for a qmac 10 controls the electrical connection between qmacs 10 in an array of qmacs 10 with a switch circuit 18 (also designated as S in the figures) connected to the output of bit multiplier 14 and to bit capacitor 16. When switch circuit 18 is on, charge Q representing the product of bits A and B is deposited on bit capacitor 16 through the left transistor of switch circuit 18. When switch circuit 18 is off, the left transistor is turned off, an inverter comprising the center transistor in switch circuit 18 applies a positive signal to a connection switch comprising the right transistor of switch circuit 18, connecting bit capacitors 16 in parallel.

Switch circuit 18 of FIG. 4A is a simplified circuit and more complex circuits can be implemented to provide the switch function and are included in the present disclosure. Thus, in a first mode, switch circuit 18 is on and the product of the multiplication by bit multiplier 14 is separately and individually applied to transfer charge to bit capacitor 16 in each qmac 10. In a second mode, switch circuit 18 is off, bit capacitors 16 are connected in parallel and the charges Q on bit capacitors 16 in each qmac 10 are isolated from bit multiplier 14 and are summed to provide the accumulated value output O. A clear circuit 19 (also designated as C in the figures) connected across bit capacitor 16 can remove charge Q across bit capacitors 16 and prepare qmac 10 to perform a next multiplication with new single-bit digital values A and B. FIG. 4B shows an abstraction of the single-bit multiply-accumulate circuit 10 of FIG. 4A where A and B are the single-bit digital storage elements 12, M is bit multiplier 14, S is switch circuit 18, and C is clear circuit 19.

FIG. 4C illustrates a multiply-accumulate cycle for a qmac 10. Load signals A and B are set to store the corresponding values in storage elements 12, for example provided by a computer or other state machine controller and are multiplied by bit multiplier 14. At the same time, the clear signal is high and the switch signal is low to isolate and clear bit capacitor 16. Once bit capacitor 16 is cleared, the clear signal is set low and the switch signal can be set high to deposit charge Q representing the product of A and B in bit capacitor 16. Once charge Q is loaded into bit capacitor 16, the switch signal is set low to isolate bit multiplier 14 from bit capacitor 16 and to connect all of bit capacitors 16 in parallel, thereby summing charges Q on bit capacitors 16 to provide accumulated value output O. The summed charges Q equal to output O, properly scaled, can be converted to a digital value with an analog-to-digital converter 30 or used for further computation as an analog value. The entire operation can be done in two cycles as switch circuit 18 changes from the first mode to the second mode.

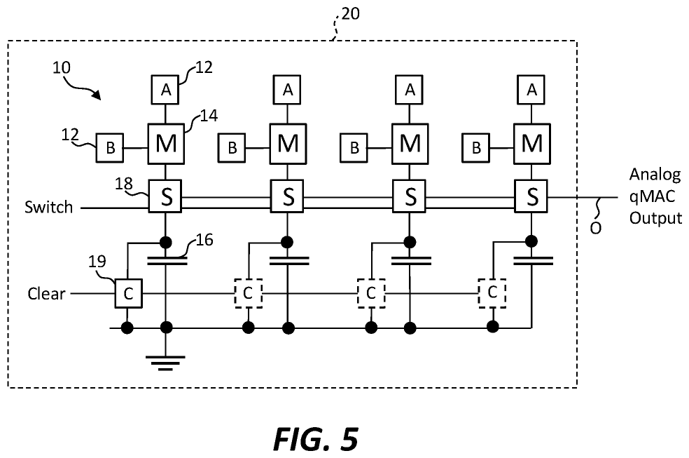

FIG. 5 illustrates an array of qmacs 10 forming hybrid multiply-accumulate circuit 20 using the abstract representation of FIG. 4B. In some embodiments, a single clear circuit 19 can be used to clear charge from all of bit capacitors 16 connected when switch circuit 18 is off, but switch circuits 18 connected between bit capacitors 16 can interfere with charge removal for all of bit capacitors 16. In some embodiments clear circuit 19 is provided for each qmac 10 and clear circuits 19 are controlled in common, as are switch circuit 18, in hybrid multiply-accumulate circuit 20.

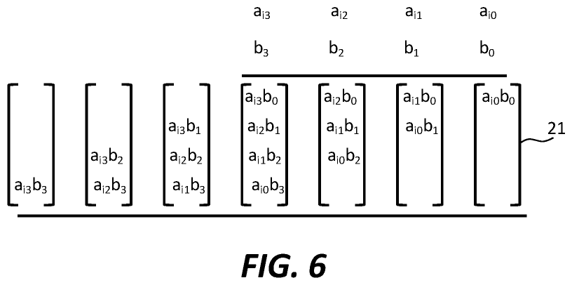

FIG. 6 illustrates a complete multiplication for two binary, multi-digit, multi-bit values. FIG. 6 illustrates a case with values having four bits, but any number of bits can be used for a hybrid multiply-accumulate circuit 20 having a number of qmacs 10 corresponding to the number of bits multiplied. The number of qmacs 10 in each hybrid multiply-accumulate circuit 20 corresponds to the number of bits in A and the number of hybrid multiply-accumulate circuits 20 corresponds to the number of multiply-accumulate calculations to be done at the same time. Where the number of qmacs 10 is less than the number of bits in A or the number of multiply-accumulate calculations to be done at the same time is less than the number of bits in B, partial calculations can be performed and the products stored and combined under the control of an external computer or controller such as a state machine.

As shown in the 4-bit example of FIG. 6, each row of products shown is a multiplication of one bit of value B times the bits of value A. The rows are spatially shifted with respect to each other in FIG. 6 to represent the relative magnitude (place) of the products in each row as is conventional for multiplication written manually on paper. The products (multiplied values) of each column 21 of products (having the same magnitude or place) are summed in each hybrid multiply-accumulate circuit 20 to form an accumulated result (summation output value O) as shown in FIG. 5. Each column 21 of products can be computed and summed with a different hybrid multiply-accumulate circuit 20. The accumulated results (output value O) of the hybrid multiply-accumulate circuits 20 are then summed (added together) to provide a final value of the multi-bit multiplication.

The multiplication and accumulation of each column 21 of products can be performed by a one-dimensional array of qmacs 10. As shown in FIG. 7, each column of qmacs 10 forms a hybrid multiply-accumulate circuit 20 sharing a common B storage element 12. The array of qmacs 10 in each hybrid multiply-accumulate circuit 20 (in this example corresponding to the multiplication illustrated in FIG. 6) calculates and sums a column 21 of products as output value O. Each column 21 of products is computed with a separate hybrid multiply-accumulate circuit 20. The output values O of each hybrid multiply-accumulate circuit 20 can be added together. Because each column 21 of products has a different place value (relative magnitude) the values in each column 21 of products must be scaled to multiply them by their place value, e.g., by one to 6 places to multiply them by 2, 4, 8, 16, 32, or 64, before they are added. Multiple multiplication operations can be performed without reloading the bit values (B storage elements 12) where the bits do not change, for example if the bit values represent weights that are common to multiplying multiple input values.

The array of hybrid multiply-accumulate circuit 20 forming a hybrid multi-bit multiplier 22 provides extremely fast operation having far fewer cycles than conventional digital circuits. Furthermore, the addition steps for summing the output values O (if done digitally) can be divided into stages (e.g., adding pairs of values at a time) and pipelined so that operation is even faster and multiply-accumulate operations for different values can be overlapped in time, for example under the control of a computer or state-machine controller.

In some embodiments of the present disclosure, the addition of output values O from the hybrid multiply-accumulate circuits 20 are calculated digitally. In some embodiments, the addition of output values O from the hybrid multiply-accumulate circuits 20 are calculated using analog circuits. As shown in FIG. 7, the output values) are converted with analog-to-digital converters 30 to provide digital bit values stored, for example, in a register or other memory, the digital bit values are scaled, for example by shifting them relative to each other (each shift corresponding to a power of two), and the scaled bit values summed using a digital adder.

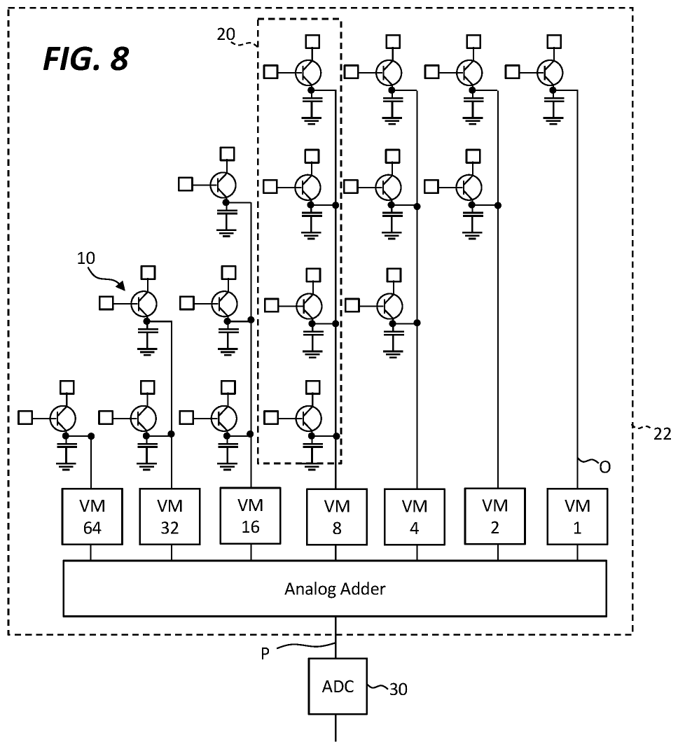

As shown in FIG. 8, the analog summation result of each hybrid multiply-accumulate operation (column of qmacs 10) is a voltage (or charge) that is multiplied by an amount corresponding to the place of the analog sum (e.g., by a voltage multiplier VM) and the multiplied analog sums are added together, for example using an analog adder, and the final summation converted to a digital value with an analog-to-digital converter 30. In such embodiments, the entire calculation can be done in two switch cycles (excluding any clear or load cycles) providing very fast operation compared to conventional implementations. FIG. 8 illustrates embodiments with separate storage elements 12 for each qmac 10.

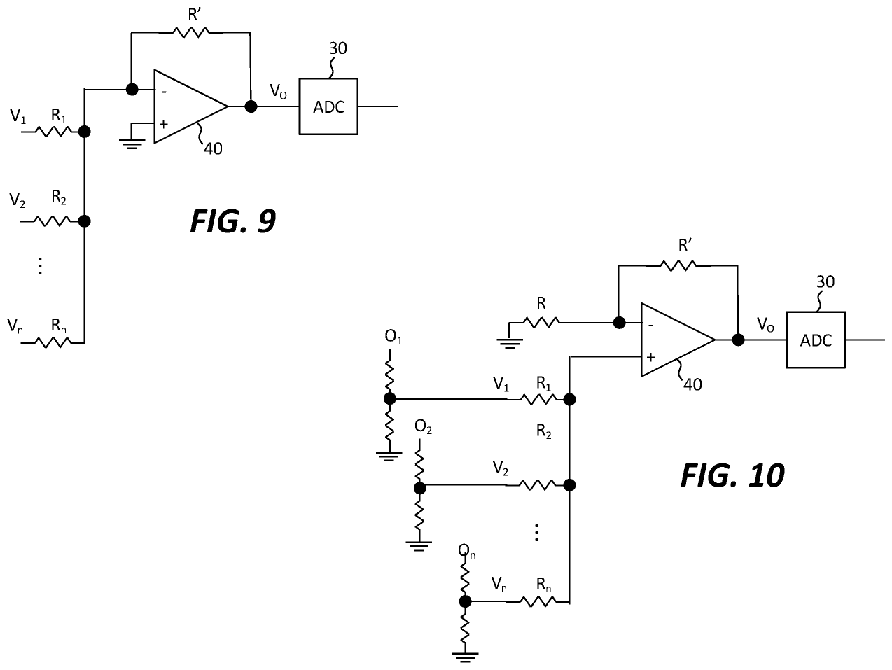

The analog voltage multiplication and summation can be, in some embodiments, implemented using operational amplifiers (op amps) 40 configured in a summation mode. FIG. 9 illustrates an inverting summing (adding) operational amplifier 40. The output Vo of the op amp 40 is equal to the sum of each of the voltages V₁ to V_{N} times the ratio of R′/Rₙ where n is the specific column and N is the number of columns 21 of products to be added (e.g., seven in the example of FIG. 7). Each voltage corresponds to the output O of a column of qmacs 10. For example, R1 can correspond to the lowest place value to be summed so R′/R₁=1/64, R′/R₂=1/32, R′/R₃=1/16, R′/R₄=1/8, R′/R₅=1/4, R′/R₆=1/1, and R′/R₇=1. The inverted output of op amp 40 can be converted to a digital value using an analog-to-digital converter 30 and scaled appropriately.

FIG. 10 illustrates a non-inverting summing (adding) operational amplifier 40. The output Vo of the op amp 40 is equal to the sum of each of the voltages V₁ to V_{N} times the ratio of R′/R where R₁-R_{N} are each equal. The voltage values V₁-V_{N} can be scaled with a voltage divider implemented with resistors. For example, the resistors connected to V₁ can have a ratio of 63:1, the resistors connected to V₂ can have a ratio of 31:1, the resistors connected to V₃ can have a ratio of 15:1, and so forth top scale the voltages to correspond to the place of the value added. The output of the op amp 40 can be scaled by the ratio of (R+R′)/R (for example 64) and converted to a digital value using an analog-to-digital converter 30.

The embodiments of FIGS. 7 and 8 with analog summing can provide faster operation and the embodiments of FIG. 6 with digital summing can provide greater precision. Embodiments of the present disclosure are not limited by the number of bits illustrated. For example, a hybrid multiply accumulator circuit 20 can have 64, 128, 256, 512, 1024, 2048, 4096, 8192, or 16384 qmacs 10 or more, and an equal number of a hybrid multiply-accumulate circuits 20 can be employed in an array to provide high-speed multiplication with many bits. Embodiments of the present disclosure can be provided as a hardware accelerator to a conventional computer or graphic processor. Data can be supplied to the hardware accelerator in a pipeline fashion with a two or more shift registers on the input and output. Any hardware implementation of an array of hybrid multiply-accumulate circuits 20 must be sized to efficiently accommodate the sizes of the input vectors. If the array of hybrid multiply-accumulate circuits 20 is too large for the task, much of the circuit is not used (e.g., the number of qmacs 10 is too large). If the array of hybrid multiply-accumulate circuits 20 is too small, the vector multiplication must be broken down into smaller vectors; too many small vectors likewise lead to inefficiency.

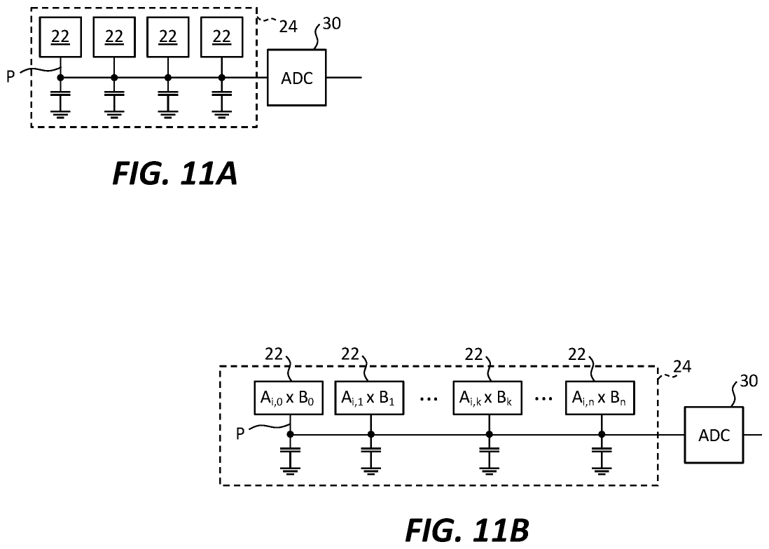

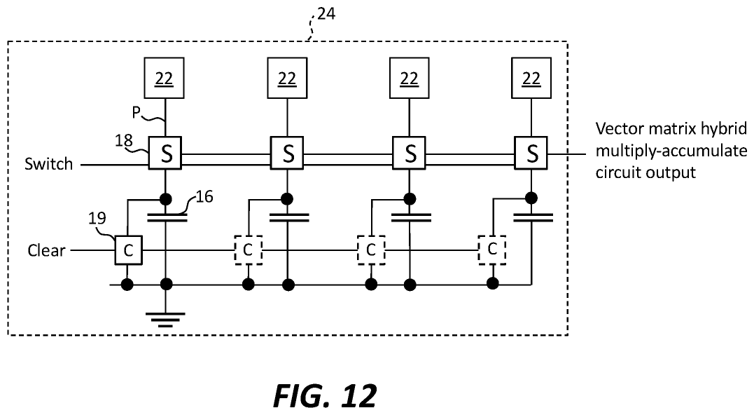

As shown in FIG. 6, a two-dimensional multiplication array of single-bit multiply-accumulate circuits 10 can perform a multi-bit multiplication (e.g., as shown in FIGS. 7 and 8). A hybrid multi-bit multiplier 22 comprising multiple arrays such as those of FIGS. 8 and 9, forming a hybrid matrix multiply-accumulate circuit 24 can compute an entire vector multiplication. Each multi-bit multiplication for a vector multiply-accumulate (e.g., as shown in FIG. 1B) can produce a digital product (as shown in FIG. 7 or after analog-to-digital conversion of analog sum output value O) and the digital products can be added digitally using digital adders. In some embodiments, each multi-bit multiplication for a vector multiply-accumulate (e.g., as shown in FIG. 1B) can produce an analog product (output value O as shown in FIG. 8) and the analog products can be added using a similar circuit as is shown in FIGS. 1-6. The analog product P (shown in FIG. 8) can be deposited in a capacitor (e.g., similar to bit-capacitor 16 but greater storage capacity for larger charges) using deposition circuitry similar to that of bit multiplier 14. As shown in FIG. 12 switch and clear circuits 18, 19 similar to those of FIG. 5 can deposit charge Q on the capacitors and the charges can be summed by connecting the capacitors in parallel and then converting the summed charge with an analog-to-digital converter 30 to provide an entire vector matrix multiplication in one cycle. FIG. 11A illustrates the hybrid matrix multiply-accumulate circuit 24 and FIG. 11B associates the hybrid multi-bit multiplier 22 with the multiplicands in the vector multiply-accumulate calculation.

Embodiments of the present disclosure can provide very low-voltage multiply accumulate circuits 10, for example using a voltage from 10 mV to 1 V. Such a low voltage provides low-power operation. A bit-multiplier 14 using a conventional AND gate can require, for example, six relatively large transistors operating at a relatively high voltage to implement a bit-multiply circuit that can adequately control the charge Q deposited on analog storage circuit 16 (e.g., from 1.65-5 V). In contrast and as shown in FIG. 13, bit-multipliers 14 of the present disclosure can comprise serially connected serial switch circuits 15 that can operate at relatively low voltages (e.g., no greater than 1 V and as low as 10 mV) and low power and can adequately control the charge Q deposited on analog storage circuit 16 with, for example, only four relatively small transistors.

As shown in FIG. 13, a series of three serial switch circuits 15 and analog storage circuit 16 can implement a qmac 10 functionally similar to the circuits illustrated in FIGS. 4A and 4B. Each serial switch circuit 15 has two differential voltage inputs (V and V with a bar, where Vbar is the inverted value of V), two voltage inputs In and In with a bar, where Inbar is the inverted value of In), and an output O. Thus, each of the signals A, B, and Switch in FIG. 13 and FIG. 14 (discussed in more detail below) is a differential signal. The first serial switch circuit 15 in the series has a reference voltage V_{REFP} (e.g., V_{REF}, a high or positive value such as 10 mV) and its inverted value V_{REFN} (e.g., a low or negative values such as 0 mV) as the two voltage inputs and a value A (e.g., a weight value) and its inverted value Abar as the two input values. As shown in the FIG. 13 inset of serial switch circuit 15A, if A is high (e.g., positive or 10 mV) and Abar is consequently low (e.g., 0 mV), the output O is V_{REF}, as indicated by the non-dashed line connections. As shown in the FIG. 13 inset of serial switch circuit 15B, if A is low (e.g., negative or 0 mV) and Abar is consequently high (e.g., 10 mV), output O is V_{REFN}, as indicated by the non-dashed lines Thus, if A is positive, O is positive and if A is negative, O is negative. The second serial switch 15 in the series has input values B and its inversion Bbar, takes value O from the first serial switch 15 as the V_{REFP} positive value, and V_{REFN} as the inverted voltage value (e.g., 0 volts). Thus, if O is low (negative), no matter what value B has, the output P from the second serial switch circuit 15 will be low (negative). If O is high (positive) and if B is high (positive), the output O from the second serial switch circuit 15 will be high (positive), and if B is low the output P from the second serial switch circuit 15 will be low (negative). Thus, the first two serial switch circuits 15 perform an AND function with reduced circuitry and power.

A third serial switch circuit 15 can be used to implement the switch circuit 18 and has input switch values and its inversion (corresponding to the switch value of FIGS. 4A, 4B), takes value O from the second serial switch 15 as the V_{REF} value, and a common V_{SUM} connection as the inverted voltage value. Thus, if the switch is high, output O charges analog storage circuit 16. If the switch is low, the charge Q on analog storage circuit 16 is commonly connected to any other analog storage circuit 16 in an array of qmacs 10 (e.g., as shown in FIG. 3 as the analog qmac 10 array output), providing a sum operation.

FIG. 14 illustrates some embodiments of a low-voltage qmac 10 comprising three serially connected serial switch circuits 15. Each switch circuit 15 comprises a pair of simple MOS (metal-oxide semiconductor) transistors having separate differential inputs and a common output. One of the pair of simple MOS transistors is controlled by a positive control signal and the other by an inverted (negative) version of the same control signal, for example the positive and negative outputs of any single-bit storage element 12 (e.g., a D-flipflop or pairs of inverters as illustrated and described with respect to FIG. 2). The function of the circuit is as described above with respect to FIG. 13. Such a series of serial switch circuits 15 can require fewer, simpler transistors that operate at a much lower voltage (e.g., one percent or less than one percent, such as 0.624 percent, or 10 mV instead of 1.65 volts) and therefore require much less power. The combined (added) voltage on analog storage circuits 16 can be:

$${V}_{SUM} = ( ( n * {V}_{REFP} ) + ( N - n ) * {V}_{REFN} ) ) / N .$$

$$Where$$

$${V}_{REFN} = 0 volts :$$

$${V}_{SUM} = ( n * {V}_{REFP} ) / N ,$$

where n is the number of capacitors and N the number of qmacs 10 connected in a row. VSUM can then be scaled or converted as described above. (FIG. 14 does not include a clear circuit 19.)

Thus, according to some embodiments of the present disclosure, a hybrid matrix multiplier comprises digital storage elements 12, each of digital storage elements 12 operable to store a digital value, a multiply circuit 14 for multiplying the stored digital values to produce a product, an analog storage circuit 16 operable to store the product, and a power connection (e.g., V_{REFP} and V_{REFN}) for providing power to operate digital storage elements 12, multiply circuit 14, and analog storage circuit 16. The power connection can have a voltage no greater than one V, no greater 500 mV, no greater than 100 mV, no greater than 50 mV, or no greater than 10 mV. The bit-multiply circuit 14 can comprise serially connected switches 15.

In some embodiments, a hardware implementation of hybrid matrix multiply-accumulate circuit 24, hybrid multi-bit multiplier 22, or hybrid multiply-accumulate circuit 20 is not exactly matched to the calculation desired for a specific application. For such applications, the calculation can be divided into sub-problems that are better matched to the available hardware and the results combined to provide the desired computation. The sub-problems can be done sequentially in time so that the hardware is time-shared or time multiplexed. Some of the values (for example the bits for multiplicand B) can be stored in storage elements 12 for multiple hardware operations, thereby reducing power and time used in the hardware.

Embodiments of the present disclosure enable vector multiply-accumulate calculations using very little energy at very high rates. Rather requiring n loops of a program (e.g., as shown in FIGS. 1C and 1D), each with multiple machine code cycles required to execute the program, the entire calculation is done in a single cycle. Many large matrix operations, for example in machine learning applications, have many zero values in the matrix and a relatively lower bit precision is required to iterate a solution to a matching problem. Thus, embodiments of the present disclosure provide an efficient circuit for such applications.

In some embodiments of the present disclosure, a multi-bit digital multiplication is performed in a single step, for example using multiple single-bit multiply accumulate circuits 10 in a hybrid multiply-accumulate circuit 20, as shown in FIGS. 2 and 3. Two multi-bit digital values can be multiplied in a single step using arrays of hybrid multiply-accumulate circuits 20 as illustrated in FIGS. 6-8. In such hybrid multi-bit multipliers, increased accuracy is provided by carefully matching the operational performance of bit-multiply circuits 14 (for example comprising the series of serial switch circuits 15) so that the charged stored by each bit-multiply circuit 14 is the same and the analog sum from the parallel-connected analog storage circuits 16 is correct, at least within the error of any analog-to-digital converter 30.

In some embodiments of the present disclosure, rather than matching the operational performance of bit-multiply circuits 14, a single bit-multiply circuit 14 is used repeatedly (e.g., iteratively over time so that single bit-multiply circuit 14 is shared over time) to accumulate a bit-product in an accumulator storage circuit 17 and no circuit matching is needed. Although the repetition requires time, the single bit-multiply circuit 14 and accumulator product circuit 17 can be very small (e.g., comprising three transistors (as shown in FIG. 14) and an additional accumulator capacitor. Thus, many millions or even billions of such circuits can be constructed in an integrated circuit and provide very fast matrix multiplication with relatively little energy use compared to existing digital multipliers.

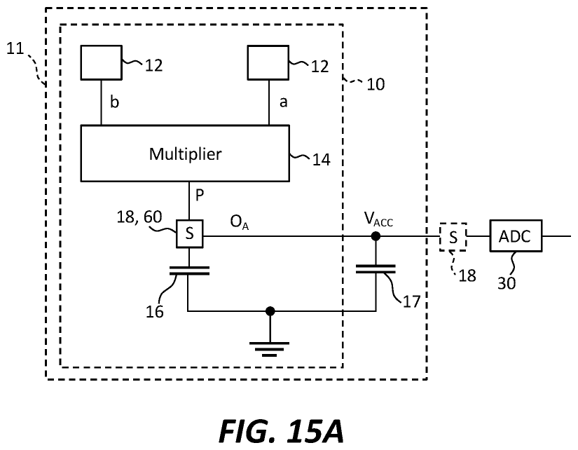

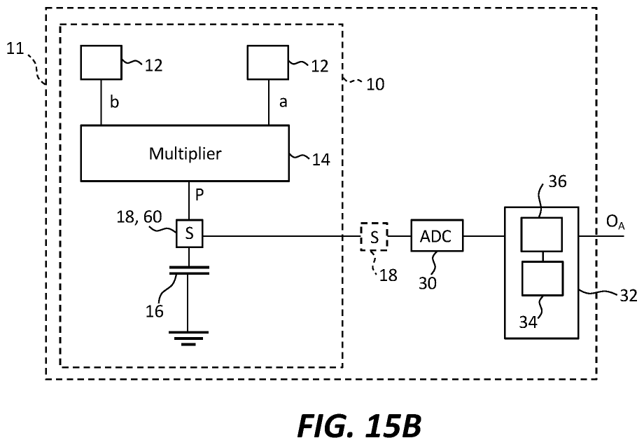

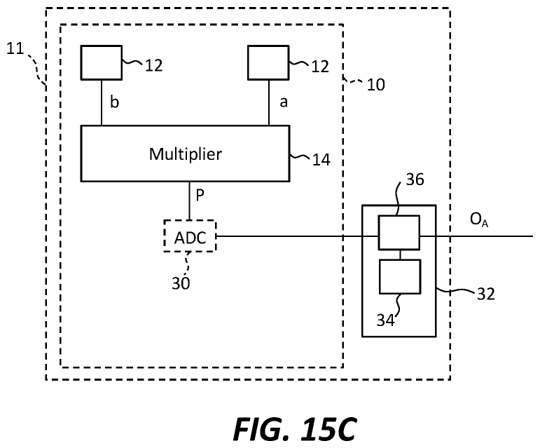

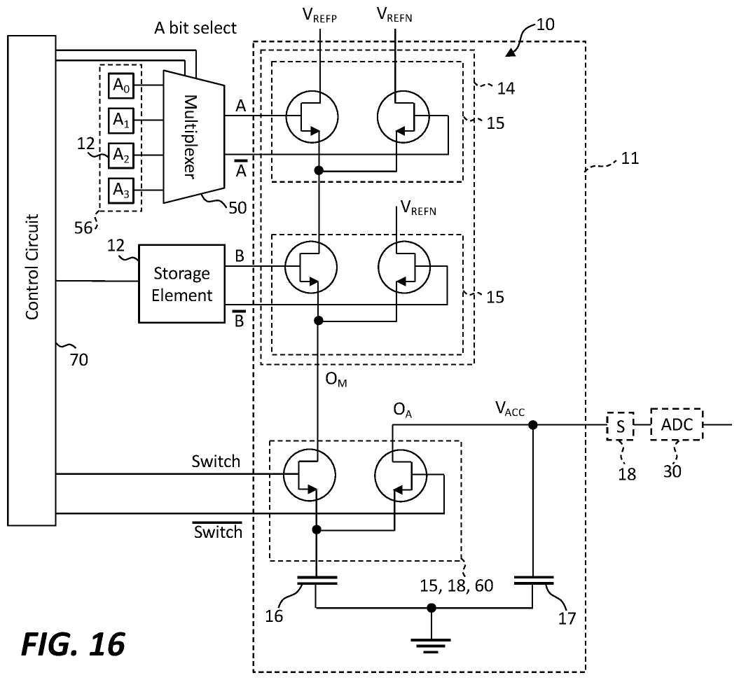

FIG. 15A illustrates a simple hybrid iterative single-bit multiply accumulate circuit 11 (iqmac 11) comprising a single-bit multiply accumulate circuit 10 with a product storage circuit 16 (capacitor 16) electrically connected in parallel with an accumulator storage circuit 17 (e.g., a capacitor 17 having the same capacitance as the product storage circuit 16 of the single-bit multiply accumulate circuit 10) by switch 18 which serves as an accumulation switch 60. Accumulation switch 60 can be the same as, substantially similar to, or identical with differential switch 18 of single-bit multiply accumulate circuit 10, as shown in more detail in FIG. 16. FIG. 16 illustrates the single-bit multiply circuit 14 of FIG. 14 with the addition of accumulator storage circuit 17 forming iterative single-bit multiply accumulate circuit 11. Optionally, the output of accumulator storage circuit 17 can be connected through an optional switch 18 to an analog-to-digital converter 30.

FIG. 15A shows the multiplication of two single-bit values stored in two corresponding single-bit storage elements 12. When switch 18 is set in multiplication mode (first mode), product P is stored in product storage circuit 16 (capacitor 16) as described with respect to FIGS. 2 and 14 above. When switch 18 is set to accumulate mode (second mode), any charge stored in product storage circuit 16 is shared (combined) with any charge stored in accumulator storage circuit 17, similar to the accumulating sum shown in FIG. 3, except that only two capacitors 16, 17 are present in iterative single-bit multiply accumulate circuit 11. Multiple bit products can be accumulated in the two capacitors by repeatedly providing bits in storage elements 12, setting switch 18 in multiplication mode, depositing a charge representing the bit product of storage elements 12 in product storage circuit 16, and setting switch 18 in accumulation mode to combine the charge in capacitor 16 and capacitor 17.

FIG. 15B illustrates a simple hybrid iterative single-bit multiply accumulate circuit 11 (iqmac 11) comprising a single-bit multiply accumulate circuit 10 that provides a bit product stored in product storage circuit 16 (capacitor 16) whose value is digitized by an analog-to-digital converter 30 (to a one or zero digital bit product). In some embodiments and as shown in FIG. 15C, single-bit multiply accumulate circuit 10 actually produces a voltage that is a digital voltage in which case a product storage circuit 16 and separate analog-to-digital converter 30 is not required. Digital bit accumulator 32 receives each digital bit product and combines it with a multi-bit accumulated digital value in accumulating digital storage circuit 34 (e.g., a memory or register). Each combination includes scaling the accumulated digital value in accumulating digital storage circuit 34. Combining the digital bit product with the accumulated digital value can comprise storing a value in the accumulating digital storage circuit if the digital bit product is one and the accumulated digital value is zero, keeping the same accumulated digital value if the digital bit product is one and the accumulated digital value is non-zero, or scaling the accumulated digital value by two if the product is zero, as described further below. The combination can be implemented with simple digital circuits, e.g., a state machine with a digital shift circuit 36 (e.g., a divide-by-two circuit). Such a hybrid iterative single-bit multiply accumulate circuit 11 does not require matched capacitors 16 and 17. In some embodiments, the size of a suitable state machine with a digital shift circuit 36 and accumulating digital storage circuit 34 can be relatively small, for example in comparison to the capacitors 16 and 17 and multi-bit ADC 30 of FIG. 15A. In particular, in embodiments such as FIGS. 15B and 15C, no multi-bit ADC 30 is required, reducing iqmac 11 circuit size and reducing the time and power required for the operation.

As shown in FIG. 16, a single bit can be multiplied by multiple bits in a multi-bit value by applying the single bit B to one input of bit-multiply circuit 14 and successively applying the bits (in this example A₀ to A₃) of the multi-bit value A to the other input of bit-multiply circuit 14. Successive bit application can be in bit order from low bit to high bit by storing the multi-bit value in a register (memory) 56 and successively multiplexing successive bits from register 56 and applying the multiplexed bit to bit-multiply circuit 14 under the control of a control circuit 70 that can provide the bit selection value for multiplexer 50 and the multi-bit value A in register 56.

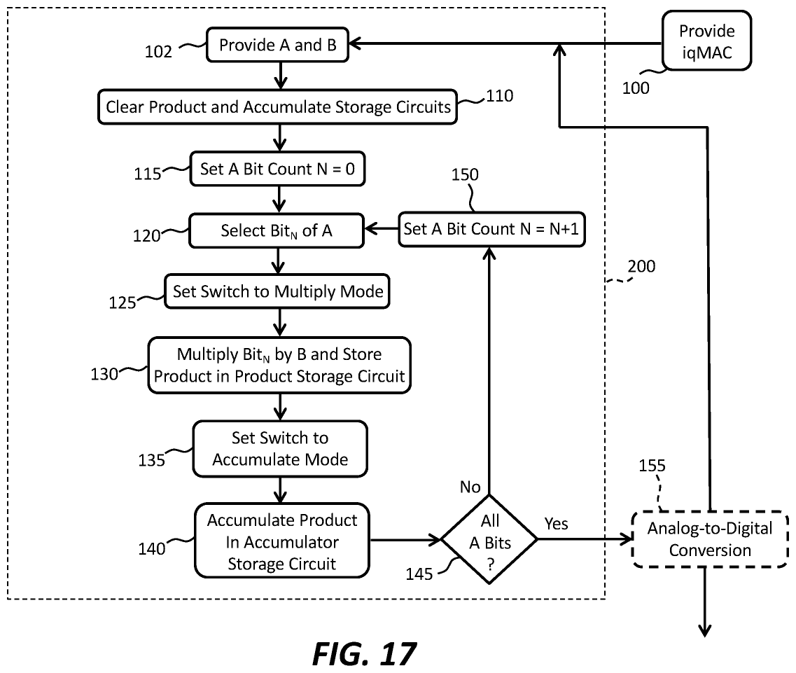

As shown in FIG. 17, a single bit B can be multiplied by a multi-bit value A by first providing an iqmac 11 in step 100 and then clearing product storage circuit 16 and accumulator storage circuit 17 in step 110 (e.g., set their values to zero, for example by connecting them to ground with a clear circuit C as illustrated in FIGS. 4A-4C). Control circuit 70 provides a single-bit value B to storage element 12 and a multi-bit value A in register 56 in step 102 and sets a bit count value N to zero in step 115. Steps 102 and 110 can be done in any order. Bit N of multi-bit value A is selected by multiplexer 50 in step 120 and switch 18 is set to multiply (first) mode under the control of control circuit 70 in step 125. Bit multiplier 14 multiplies bit N of multi-bit value A by bit B and stores the product in product storage circuit 16 in step 130. Switch 18 is then set to accumulate (second) mode in step 135, connecting the storage circuits in parallel so that any charges in product storage circuit 16 and accumulator storage circuit 17 are combined and shared between the product and accumulator storage circuits 16, 17 in step 140. Bit count N is then tested in step 145 to discover if all bits of multi-bit value A have been multiplied by bit B. If not all of the bits of multi-bit value A have been multiplied by bit B, then N is incremented (e.g., by control circuit 70) in step 150. If all bits of multi-bit value A have been multiplied by bit B (test step 145), the process is complete and a value corresponding to the product is stored in accumulator storage circuit 17. Optionally under the control of a switch 18, analog-to-digital converter 30 converts the accumulated product to a digital value in step 155. For example, the output (V_{ACC}) of iterative single-bit multiply accumulate circuit 11 can itself be switched, for example using a serial switch circuit 15 and applied to an analog-to-digital circuit 30. If all of the bits of A have not been multiplied by bit B, bit count N is incremented and steps 120 to 145 repeated until all of the bits of A are multiplied. A new multiplication can then proceed.

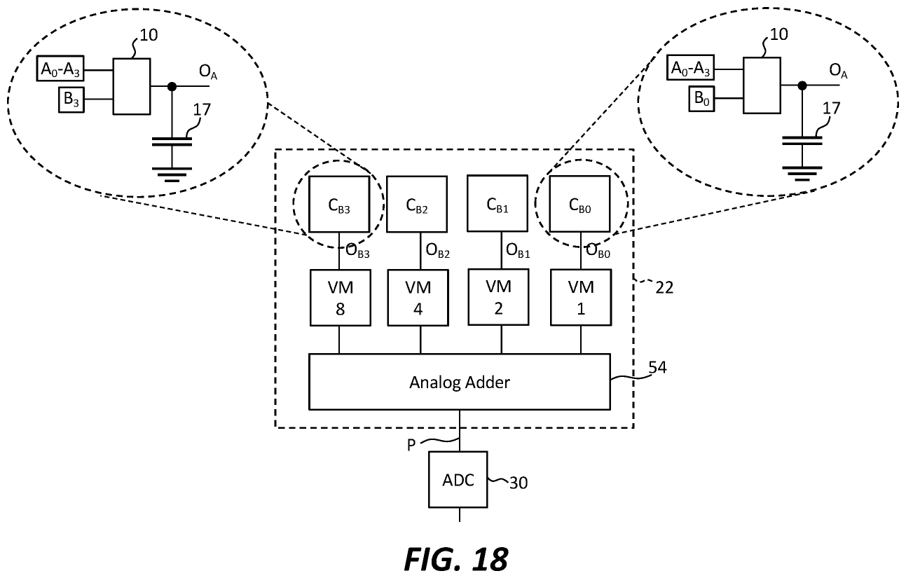

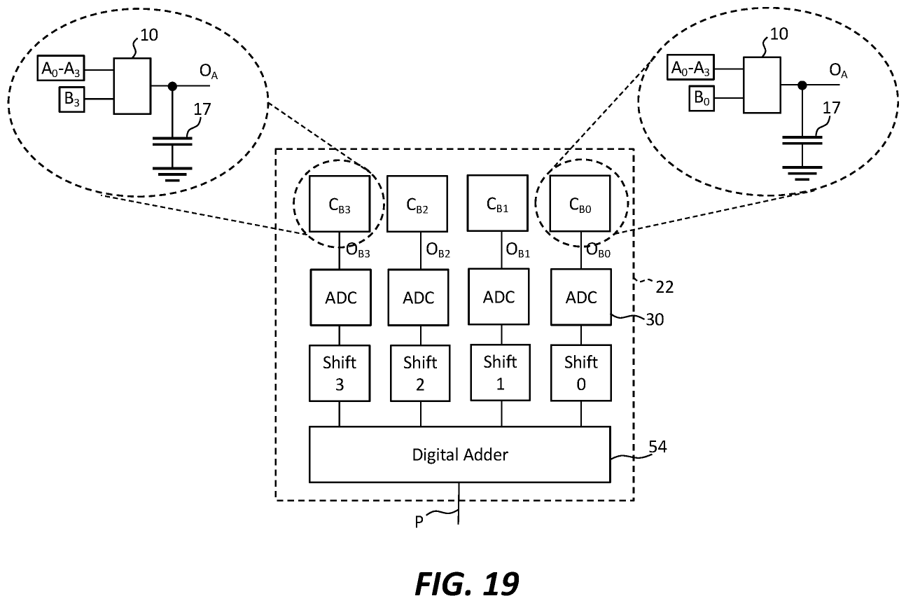

In some embodiments, an iterative single-bit multiply accumulate circuit 11 can be provided for each bit of a second multi-bit value B and each of the bits in the second multi-bit value B multiplied at the same time. Each iterative single-bit multiply accumulate circuit 11 then accumulates a sum corresponding to each row or products in FIG. 6. Thus, in this example, four iterative single-bit multiply accumulate circuits 11 each accumulate a value corresponding to a row of the calculation illustrated in FIG. 6. FIG. 18 illustrates an analog summation of the accumulated products. Each accumulated product (corresponding to a row of FIG. 6) is scaled (multiplied by a power of two corresponding to the row), for example with a voltage multiplier, and then added, for example as illustrated in FIGS. 7-9. As shown in FIG. 19, each accumulated product can be digitized with analog-to-digital converter 30, scaled with shift circuits, and then digitally summed using a digital adder 54. The top row is scaled (multiplied) by 2⁰=1 or a shift of zero places, the next row is scaled (multiplied) by 2¹=2 or a shift of one place, the following row is scaled (multiplied) by 2²=4 or a shift of two places, and the last row is scaled (multiplied) by 2³=8 or a shift of three places.

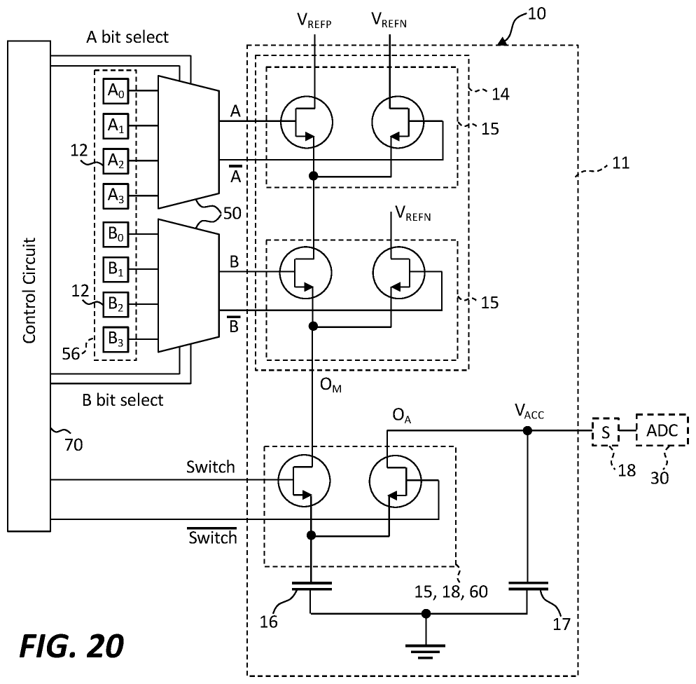

According to some embodiments of the present disclosure, a multi-bit value B can be multiplied by a multi-bit value A by iteratively applying iqmac 11 to each bit of multi-bit value B so that only one iterative single-bit multiply accumulate circuit 11 is used to compute the entire product. FIG. 20 illustrates a useful circuit that replaces storage element 12 for bit B in FIG. 16 with a multiplexer 50 under the control of control circuit 70. Control circuit 70 can store multi-bit value B in register 56 and select a bit M of multi-bit value B with multiplexer 50 and apply the selected bit to iqmac 11. Each single-bit multiplication of a bit M of multi-bit value B times multi-bit value A proceeds iteratively as described with respect to the flow diagram of FIG. 17 (e.g., in step 200).

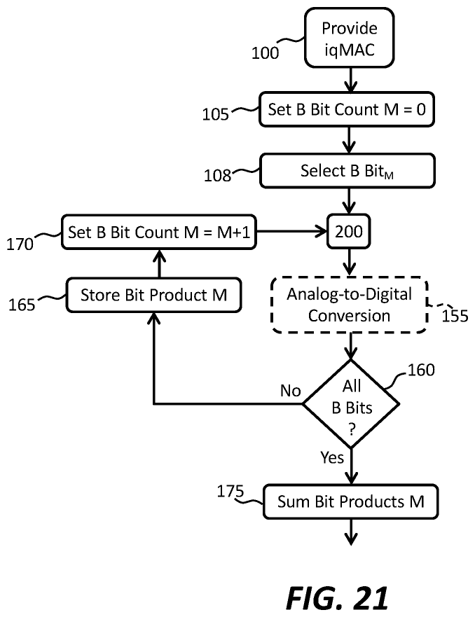

As shown in FIG. 21, multi-bit value B can be multiplied by multi-bit value A by first providing an iqmac 11 in step 100 and then setting a bit counter M to zero in step 105. The method of step 200 (FIG. 17) then proceeds for multi-bit value A and a selected bit M of multi-bit value B. If all of the bits of multi-bit value B are not multiplied by multi-bit value A (determined in step 160), the accumulated bit product is stored in step 165, for example in a capacitor if the value is a charge or a register if the value is digital (e.g., converted by analog-to-digital converter 30 in step 155) and the bit-count value M is incremented in step 170. The product of each bit of multi-bit value B times multi-bit value A corresponds to a row of the multi-bit product values illustrated in FIG. 6. Once all of the bits of multi-bit value B have been multiplied by multi-bit value A the products of each bit of multi-bit value B and multi-bit value A can be summed in step 175 as described with respect to FIGS. 7 and 8 (e.g., with an analog or a digital summation with proper care taken to scale the product of each bit of multi-bit value B before summing the result).

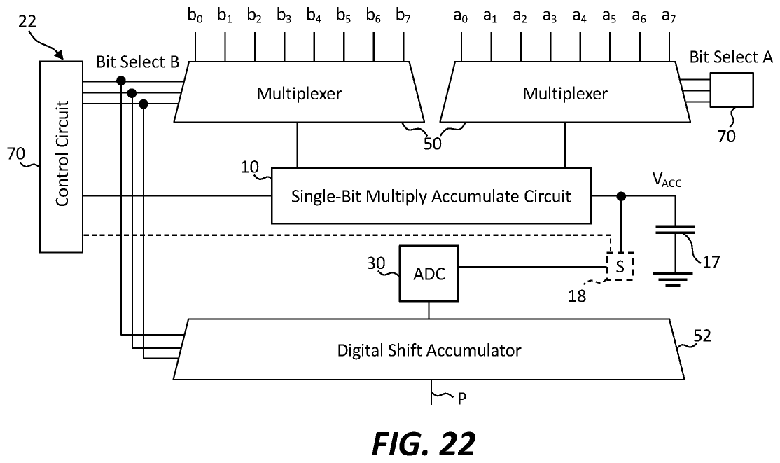

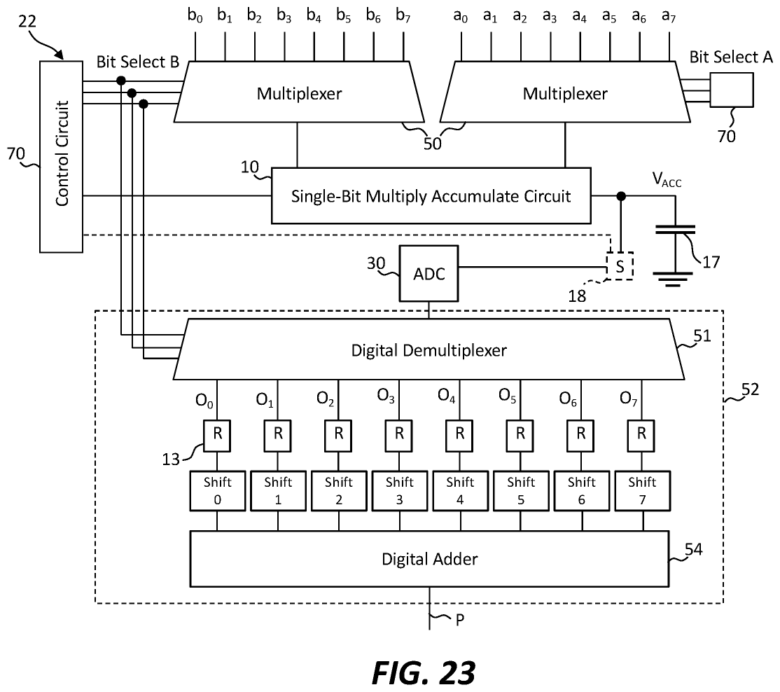

FIG. 22 illustrates a hybrid circuit for iteratively multiplying two 8-bit digital values using iterative single-bit multiply accumulate circuit 11. As shown in FIG. 22, control circuit 70 controls switch 18 and multiplexers 50 to cycle through the bits of multi-bit value A and multi-bit value B as described in FIGS. 20 and 21. Each product of a bit of multi-bit value B and multi-bit value A is converted to a digital value, scaled, and then accumulated (added to the existing value) of digital shift accumulator 52. As shown in FIG. 23, digital shift accumulator 52 can comprise a demultiplexer 51 responsive to control circuit 70 for shifting each bit of the digitized product (to scale the digitized product corresponding to the row of FIG. 6), a multi-bit register or memory 13 for storing the accumulated product, and an adder 54 for adding the scaled product to the accumulated product and storing the sum in the register. The shift (scale) can correspond to the bit of multi-bit value B selected for the multiplication with multi-bit value A. After all of the bits of multi-bit product have been multiplied with multi-bit value A and the products accumulated, the accumulated value in digital shift accumulator 52 contains the product of multi-bit values A and B.

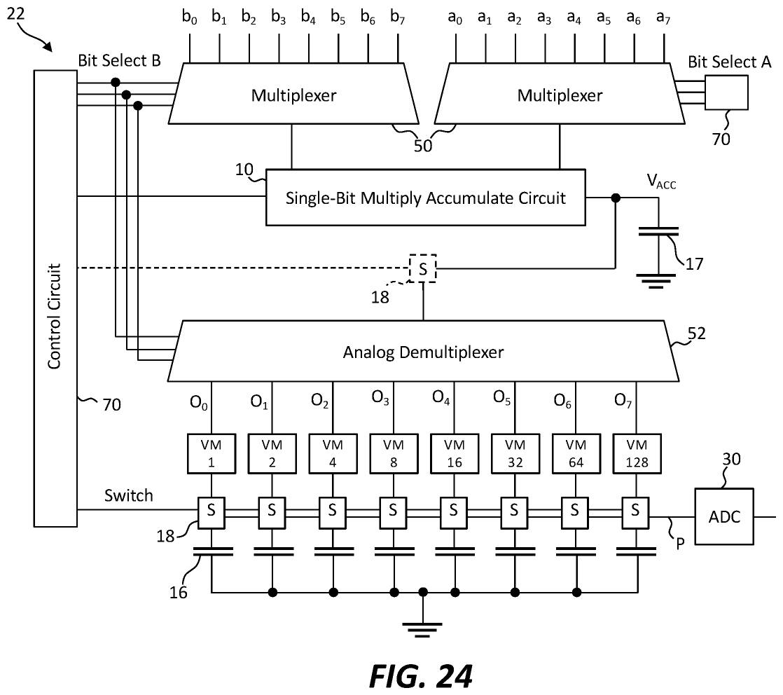

FIG. 24 performs the same function as FIG. 23 except that the product accumulation is performed with analog circuitry. As shown in FIG. 24, control circuit 70 controls switch 18 and multiplexers 50 to cycle through the bits of multi-bit value A and multi-bit value B as described in FIGS. 20 and 21. Each product of a bit of multi-bit value B and multi-bit value A is scaled (for example using a voltage multiplier) and then stored in a separate analog storage circuit 16 (e.g., a capacitor) selected with an analog demultiplexer 52. Once all of the accumulated products corresponding to rows in FIG. 6 are stored, they can be summed in one step using a circuit similar to that of FIGS. 2-5.

According to some embodiments of the present disclosure, an array multiplication can be implemented with a hybrid iterative single-bit multiply accumulate circuit 11 as illustrated in FIG. 22 for each multi-bit product, so that all of the product values are computed at the same time, but each product value is computed iteratively. According to embodiments of the present disclosure, such an array multiplier can be both fast and low-power.

Iterative single-bit multiply accumulator 11 sequentially computes a product of a single-bit B and a bit of a multi-bit value A, sequentially stores the product of each bit pair in product storage circuit 16, and accumulates the sequential products in accumulator storage circuit 17. Each consecutive bit product has a value twice that of the earlier product since the multi-bit value is a binary value. For example, a product of a single-bit value 1 and a multi-bit value 111 has three consecutive one bits. The first bit has a value of one, the second bit has a value of two, and the third bit has a value of four, corresponding to the place of the bit in the number. Thus, a sequential accumulation of the bit products must provide an appropriate scaling of the bits corresponding to the bit's place value.

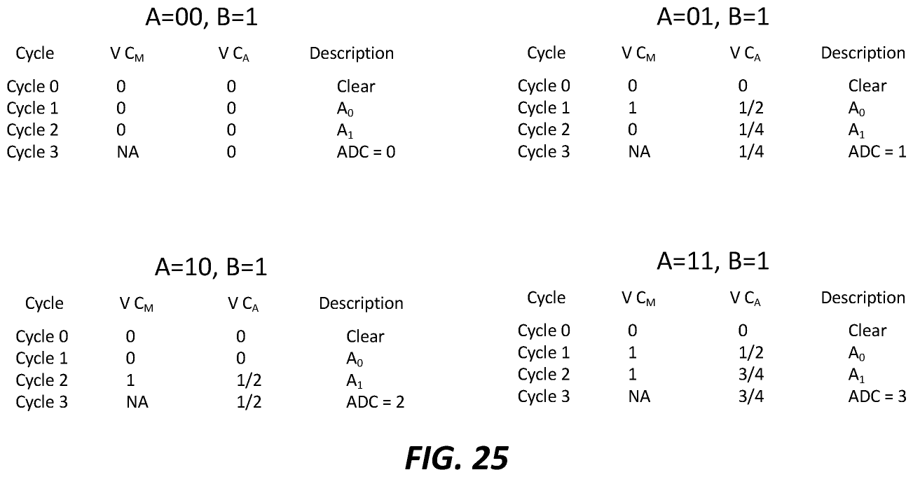

Each time product storage circuit 16 is electrically connected in parallel with accumulator storage circuit 17, the charges in the two circuits equalize as a combined and shared charge. FIG. 25 illustrates the charge combination and equalization for each possible result of a single-bit value B multiplied by a two-bit value A. If B has a value of zero, all of the products are zero and any accumulated charges are likewise zero (not shown in FIG. 25). The numbers are written in binary notation.

If B is 1 and A equals 00, the upper left columns illustrate the process. The voltage C_{M} is the charge stored in product storage circuit 16 and the voltage C_{A} is the accumulated charge relative to a charge corresponding to a one product value stored in accumulator storage circuit 17. In a clear cycle 0, the product storage circuit 16 and the accumulator storage circuit 17 are cleared. In cycle one, bit zero of A (a zero) is multiplied by B (a one) to result in a zero product, stored in product storage circuit 16 and then accumulated in accumulator storage circuit 17, both of which will store a zero charge. In cycle two, bit one of A (a zero) is multiplied by B (a one) to result in a zero product, stored in product storage circuit 16 and then accumulated in accumulator storage circuit 17, again as a zero charge. In cycle three, analog-to-digital converter 30 converts the accumulated charge in accumulator storage circuit 17 (a zero charge) to zero.

If B is 1 and A equals 01, the upper right columns illustrate the process. In a clear cycle 0, the product storage circuit 16 and the accumulator storage circuit 17 are cleared. In cycle one, bit zero of A (a one) is multiplied by B (a one) in multiply mode to result in a one product, stored in product storage circuit 16 as a one charge. Because product storage circuit 16 is a capacitor with a capacitance equal to the capacitor of accumulator storage circuit 17, a parallel connection between them (enabled by switch 18 in accumulate mode) doubles the capacitance and therefore halves the charge in each capacitor and the voltage of the capacitors so that accumulator storage circuit 17 stores a relative charge of one half. In cycle two, bit one of A (a zero) is multiplied by B (a one) to result in a zero product, stored in product storage circuit 16 in multiply mode and then accumulated in accumulator storage circuit 17 in accumulation mode. This combination combines a charge of one half in the accumulator storage circuit 17 with a zero charge in product storage circuit 16, reducing the charge and voltage in each circuit by one half, so that accumulator storage circuit 17 has a relative charge and voltage of one quarter. In cycle three, the charge is scaled by a factor of four (equal to the number of values a two-bit binary digital value can store and analog-to-digital converter 30 converts the accumulated charge in accumulator storage circuit 17 to one (four times one quarter), the product of B=1 and A=01 (one in decimal notation).

If B is 1 and A equals 10, the lower left columns illustrate the process. In a clear cycle 0, the product storage circuit 16 and the accumulator storage circuit 17 are cleared. In cycle one, bit zero of A (a zero) is multiplied by B (a one) to result in a zero product, stored in product storage circuit 16 as a zero charge. In cycle two, bit one of A (a one) is multiplied by B (a one) to result in a one product, stored in product storage circuit 16 in multiply mode and then accumulated in accumulator storage circuit 17 in accumulator mode. This combination combines a charge of zero in the accumulator storage circuit 17 with a one charge in product storage circuit 16 so that accumulator storage circuit 17 has a relative charge and voltage of one half. In cycle three, the charge is scaled by a factor of four and analog-to-digital converter 30 converts the accumulated charge in accumulator storage circuit 17 to two (four times one half), the product of B=1 and A=10 (two in decimal notation).

If B is 1 and A equals 11, the lower right columns illustrate the process. In a clear cycle 0, the product storage circuit 16 and the accumulator storage circuit 17 are cleared. In cycle one, bit zero of A (a one) is multiplied by B (a one) to result in a one product, stored in product storage circuit 16 as a one charge in multiply mode and accumulated with accumulator storage circuit 17 in accumulator mode as a one half charge and voltage. In cycle two, bit one of A (a one) is multiplied by B (a one) to result in a one product, stored in product storage circuit 16 and then accumulated in accumulator storage circuit 17. This combination combines a charge of one half in the accumulator storage circuit 17 with a one charge in product storage circuit 16 so that accumulator storage circuit 17 has a relative charge and voltage of three quarters. In cycle three, the charge is scaled by a factor of four and analog-to-digital converter 30 converts the accumulated charge in accumulator storage circuit 17 to three (four times three quarters), the product of B=1 and A=11 (three in decimal notation).

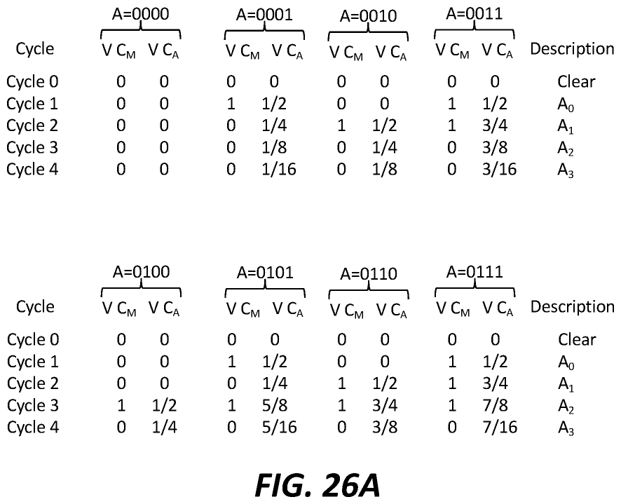

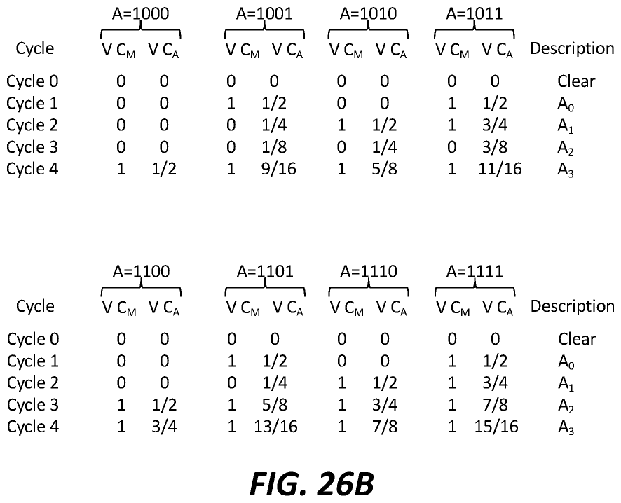

FIGS. 26A and 26B illustrate the same process for a four-bit binary value A. The product voltage (charge) in product storage circuit 16 is shown in the left side of each column pair corresponding to a value of A and the accumulated voltage (charge) in accumulator storage circuit 17 is shown in the right side of each column pair corresponding to a value of A for the indicated cycles. For A=0000, all of the products and accumulated charges are zero, resulting in a zero accumulated value.

For A=0001, the first product stored in product storage circuit 16 is a one because B is one and bit zero of A is one. Since the product one is shared equally between product storage circuit 16 and accumulator storage circuit 17, accumulator storage circuit 17 stores a relative value of one half. Thereafter, the products are zero and the charge in accumulator storage circuit 17 drops by one half each time it is shared with the charge in product storage circuit 16, so that the charge is reduced to one quarter in cycle two, one eighth in cycle three, and one sixteenth in cycle four. Since A has four bits, the accumulated charge is scaled by a factor of sixteen, resulting in a product equal to one sixteenth times sixteen or 0001 (a decimal one).

For A=0010, the first product is a zero because bit zero of A is a zero so that the first accumulated value is zero. The second product (bit one of A) is one and the corresponding accumulated relative charge is one half, since the product charge is shared equally between product storage circuit 16 and accumulator storage circuit 17. Thereafter, the products are zero because the bits of A are zero and the charge in accumulator storage circuit 17 drops by one half each time it is shared with the charge in product storage circuit 16, so that the charge is reduced to one quarter in cycle three, and one eighth in cycle four. The accumulated charge is scaled by a factor of sixteen, resulting in a product equal to one eighth times sixteen or 0010 (decimal value 2).

For A=0011, the first product is a one and the first accumulated value is one half, since the charge is shared equally between product storage circuit 16 and accumulator storage circuit 17. The second product (bit one of A) is one and the corresponding accumulated relative charge is three quarters since the charge of one in product storage circuit 16 is shared equally with a charge of one half in accumulator storage circuit 17. Thereafter, the products are zero and the charge in accumulator storage circuit 17 drops by one half each time it is shared with the charge in product storage circuit 16, so that the charge is reduced to three eighths in cycle three, and three sixteenths in cycle four. The accumulated charge is scaled by a factor of sixteen, resulting in a product equal to three sixteenths times sixteen or 0011 (decimal value 3).

For A=0100, the first product is a zero and the first accumulated value is zero. The second product is likewise zero because bit one of A is zero so the second accumulated value is zero. The third product (bit two of A in cycle three) is one and the corresponding accumulated relative charge is one half, since the charge is shared equally between product storage circuit 16 storing a one and accumulator storage circuit 17 storing a zero. Thereafter, the products are zero and the charge in accumulator storage circuit 17 drops by one half each time it is shared with the charge in product storage circuit 16, so that the charge is reduced to one quarter in cycle four. The accumulated charge is scaled by a factor of sixteen, resulting in a product equal to one quarter times sixteen or 0100 (decimal value 4).

For A=0101, the first product is a one and the first accumulated value is one half, since the charge is shared equally between product storage circuit 16 and accumulator storage circuit 17, for a relative value of one half. The second product (cycle two) is a zero because bit one of A is a zero, so that the accumulated value is an average of zero and one half, equaling one quarter. The third product (cycle three) is a one because bit two of A is a one, so that the accumulated value is an average of one quarter and one, equal to five eighths. The fourth product (cycle four) is a zero because bit three of A is a zero, so that the accumulated value is an average of zero and five eighths, equal to five sixteenths. After scaling by a factor of sixteen, the resulting product equal to five sixteenths times sixteen or 0101 (decimal 5).

For A=0110, the first product is a zero and the first accumulated value is zero. The second product (cycle two) is a one because bit one of A is a one, so that the accumulated value is an average of zero and one, equaling one half. The third product (cycle three) is a one because bit two of A is a one, so that the accumulated value is an average of one and one half, equaling three quarters. The fourth product (cycle four) is a zero because bit three of A is a zero, so that the accumulated value is an average of zero and three quarters, equaling three eighths. After scaling by a factor of sixteen, the resulting product is equal to three eighths times sixteen or 0110 (decimal 6).

For A=0111, the first product is a one and the first accumulated value is one half. The second product (cycle two) is a one because bit one of A is a one, so that the accumulated value is an average of zero and one half, equaling three quarters. The third product (cycle three) is a one because bit two of A is a one, so that the accumulated value is an average of one and three quarters, equaling seven eighths. The fourth product (cycle four) is a zero because bit three of A is a zero, so that the accumulated value is an average of zero and seven eighths, equaling seven sixteenths. After scaling by a factor of sixteen, the resulting product is equal to seven sixteenths times sixteen or 0111 (decimal 7).

FIG. 26B illustrates the accumulated results for values 1000 to 1111. The accumulated products are the same as shown in FIG. 26A, except that the final bit product is a one, so that the accumulated value of cycle three is averaged with a one to provide the final result, as shown in FIG. 26B.

FIGS. 25-26B mathematically demonstrate the iterative accumulation of charge for bit multiplications of a single bit B times a multi-bit value A as shown in FIGS. 16-19. By repeating this process for each bit of a multi-bit value B (as described in FIGS. 20 and 21, two multi-bit values can be computed at high-speed and with low power.

The calculation can be summarized mathematically. Given bit B and multi-bit value A with N bits where A(i) is bit i of multi-bit value A and the first bit (least significant bit of LSB) is A(0) for i=0 and the last bit (most significant bit or MSB) is A(N−1), the accumulated product is:

$$P = {2}^{N} * {\sum }_{i = 0}^{N - 1} ( B * A ( i ) ) / {2}^{N - i}$$

In embodiments in which a multi-bit value B having M bits and the first bit (least significant bit) is B(0) and the last bit (most significant bit or MSB) is B(M−1) is multiplied by a multi-bit value A having N bits and the first bit (least significant bit) is A(0) for i=0 and the last bit (most significant bit or MSB) is A(N−1), an accumulated product of A×B is:

$$P = {\sum }_{j = 0}^{M - 1} {2}^{N + j} {\sum }_{i = 0}^{N - 1} ( B ( j ) * A ( i ) ) / {2}^{N - i}$$

If B(j) equals zero, the summation over i need not be completed, saving time and energy in the calculation.

Embodiments of the present disclosure are not limited to the specific examples illustrated in the figures and described herein. Skilled designers will readily appreciate that various implementations of analog and digital circuits can be employed to implement the operations described and such implementations are included in embodiments of the present disclosure.

Embodiments of the present disclosure can be used in neural networks, pattern-matching computers, or machine-learning computers and provide efficient and timely processing with reduced power and hardware requirements. Such embodiments can comprise a computing accelerator, e.g., a neural network accelerator, a pattern-matching accelerator, a machine learning accelerator, or an artificial intelligence computation accelerator designed for static or dynamic processing workloads.

Having described certain implementations of embodiments, it will now become apparent to one of skill in the art that other implementations incorporating the concepts of the disclosure may be used. Therefore, the disclosure should not be limited to certain implementations, but rather should be limited only by the spirit and scope of the following claims.

Throughout the description, where apparatus and systems are described as having, including, or comprising specific elements, or where processes and methods are described as having, including, or comprising specific steps, it is contemplated that, additionally, there are apparatus and systems of the disclosed technology that consist essentially of, or consist of, the recited elements, and that there are processes and methods according to the disclosed technology that consist essentially of, or consist of, the recited processing steps.

It should be understood that the order of steps or order for performing certain action is immaterial so long as the disclosed technology remains operable. Moreover, two or more steps or actions in some circumstances can be conducted simultaneously. The disclosure has been described in detail with particular reference to certain embodiments thereof, but it will be understood that variations and modifications can be effected within the spirit and scope of the following claims.

### Parts List

C clear circuit
M multiplier circuit/multiplier
O output value
P product
S switch/switch circuit
VM voltage multiplier
10 qmac/single-bit multiply-accumulate circuit
11 iqmac/iterative single-bit multiply accumulate circuit
12 single-bit storage element
13 multi-bit storage element
14 bit multiplier/bit-multiply circuit
15, 15A, 15B serial switch circuit
16 capacitor/analog storage circuit/product storage circuit
17 capacitor/analog storage circuit/accumulator storage circuit
18 switch/switch circuit
19 clear/clear circuit
20 hybrid multiply-accumulate circuit
21 column of products
22 hybrid multi-bit multiplier
24 hybrid matrix multiply-accumulate circuit
30 analog-to-digital converter
32 digital bit accumulator
34 accumulating digital storage circuit
36 state-machine and digital shift circuit
40 operational amplifier/op amp
50 multiplexer
51 demultiplexer
52 digital shift accumulator
54 adder
56 register/memory
60 accumulation switch
70 control circuit
100 provide qmac step
102 provide A and B values step
105 set B bit count M=0 step
108 select B bit_{M} step
110 Clear C_{M} and C_{A} step
115 set A bit count N=0 step
120 select A bit_{N} step
125 set switch to multiply mode step
130 multiply bit N and store product in step
135 set switch to accumulate mode step
140 accumulate products step
145 test all A bits multiplied step
150 set A bit count N to N+1 step
155 analog-to-digital conversion step
160 test all B bits multiplied step
165 store bit product M
170 set B bit count M to M+1 step
175 sum bit products M step
200 multiply multi-bit value by a single bit step

1. A time-shared multiply-accumulate circuit, comprising:
a product storage circuit;
a multiply circuit operable to receive a first input value, receive a second input value, produce a product of the first input value and the second input value, and store the product in the product storage circuit;
an accumulator storage circuit for storing an accumulated value; and
an accumulation switch connecting the product storage circuit to the accumulator storage circuit that is operable to electrically connect the product storage circuit and the accumulator storage circuit in parallel or to electrically disconnect the product storage circuit from the accumulator storage circuit.

2. The time-shared multiply-accumulate circuit of claim 1, comprising a first multiplexer operable to select one of multiple first input values input to the first multiplexer and wherein the multiply circuit is operable to receive the selected one of the multiple first input values from the first multiplexer, receive the second input value, and produce a product of the selected one of the multiple first input values and the second input value.

3. The time-shared multiply-accumulate circuit of claim 2, comprising a second multiplexer operable to select one of multiple second input values input to the second multiplexer and wherein the multiply circuit is operable to receive the selected one of the second input values from the second multiplexer and produce a product of the selected one of the multiple first input values and the selected one of the second input values.

4. The time-shared multiply-accumulate circuit of claim 1, wherein the product storage circuit and the accumulator storage circuit are analog storage circuits that store charge.

5. The time-shared multiply-accumulate circuit of claim 4, wherein the product storage circuit and the accumulator storage circuit are capacitors.

6. The time-shared multiply-accumulate circuit of claim 1, wherein the multiply circuit is a single-bit-multiply circuit.

7. The time-shared multiply-accumulate circuit of claim 1, wherein the multiply circuit comprises serially connected serial switch circuits.

8. The time-shared multiply-accumulate circuit of claim 7, wherein the accumulation switch is a serial switch circuit serially connected with the serial switch circuits of the multiply circuit.

9. The time-shared multiply-accumulate circuit of claim 7, wherein the multiply circuit comprises serially connected serial switch circuits, and wherein one or more of the serial switch circuits of the multiply circuit and of the accumulation switch are differential switches.

10. The time-shared multiply-accumulate circuit of claim 1, wherein operating the accumulation switch to connect the product storage circuit and the accumulator storage circuit in parallel combines the accumulated value in the accumulator storage circuit with the product in the product storage circuit to provide a combined value stored in the product storage circuit and in the accumulator storage circuit.

11. The time-shared multiply-accumulate circuit of claim 1, comprising a control circuit operable to sequentially (i) provide a first input value and a second input value to the multiplier and switch the accumulation switch to store the product in the product storage circuit and (ii) switch the accumulation switch to electrically connect the product storage circuit and the accumulator storage circuit in parallel and combine the product in the product storage circuit with the accumulated value to provide a combined value stored in the product storage circuit and in the accumulator storage circuit.

12. A hybrid matrix multiplier, comprising:
time-shared multiply-accumulate circuits of claim 1; and
an adder for adding the accumulated values of the time-shared multiply-accumulate circuits.

13. The hybrid matrix multiplier of claim 12, wherein the accumulated values are analog values and comprising an analog-to-digital converter for converting the accumulated values to digital values and wherein the adder is a digital adder.

14. The hybrid matrix multiplier of claim 12, wherein the accumulated values are analog values and wherein the adder is an analog adder.

15. A hybrid method of matrix multiplication, comprising:
a) providing a multi-bit value having N bits;
b) providing a time-shared multiply-accumulate circuit of claim 1;
c) providing an input bit of the multi-bit value, providing a second input bit to the multiplier, and setting the accumulation switch to connect the product storage circuit to the time-shared multiply accumulate circuit and disconnect the product storage circuit from the accumulator storage circuit;
d) multiplying the input bit of the multi-bit value times the second input bit to form a bit product stored in the product storage circuit;
e) switching the accumulation switch to disconnect the product storage circuit from the time-shared multiply accumulate circuit and connect the product storage circuit to the accumulator storage circuit and combine the product in the product storage circuit with the accumulated value to produce a combined value in the accumulator storage circuit; and
f) repeating steps c)-e) N times until all bits of the multi-bit value are provided in bit order to produce a product of the multi-bit value and the second input bit.

16. A hybrid method of matrix multiplication, comprising:
a) providing a first multi-bit value having N bits and a second multi-bit value having M bits;
b) providing M time-shared multiply-accumulate circuits of claim 1;
c) providing an input bit of the first multi-bit value and providing a different second input bit of the second multi-bit value to the multiplier of each of the M time-shared multiply-accumulate circuits, and setting the accumulation switch to connect the product storage circuit to the time-shared multiply accumulate circuit and disconnect the product storage circuit from the accumulator storage circuit of each of the M time-shared multiply-accumulate circuits;
d) multiplying the input bit of the multi-bit value times the second input bit to form a bit product stored in the product storage circuit with each of the M time-shared multiply-accumulate circuits;
e) switching the accumulation switch to disconnect the product storage circuit from the time-shared multiply accumulate circuit and connect the product storage circuit to the accumulator storage circuit and combine the product in the product storage circuit with the accumulated value to produce a combined value in the accumulator storage circuit of each of the M time-shared multiply-accumulate circuits;
f) repeating steps c)-e) for each of the N bits of the first multi-bit value until all bits of the first multi-bit value are provided in bit order;
g) scaling the accumulated value of each of the M time-shared multiply-accumulate circuits; and
h) adding the accumulated value of each of the M scaled time-shared multiply-accumulate circuits to produce a product.

17. A hybrid method of matrix multiplication, comprising:
a) providing a first multi-bit value having N bits and a second multi-bit value having M bits;
b) providing a time-shared multiply-accumulate circuit of claims 1;
c) providing an input bit of the first multi-bit value and providing a second input bit of the second multi-bit value to the multiplier, and setting the accumulation switch to connect the product storage circuit to the time-shared multiply accumulate circuit and disconnect the product storage circuit from the accumulator storage circuit of the time-shared multiply-accumulate circuit;
d) multiplying the input bit of the first multi-bit value times the second input bit of the second multi-bit value to form a bit product stored in the product storage circuit;
e) switching the accumulation switch to disconnect the product storage circuit from the time-shared multiply accumulate circuit and connect the product storage circuit to the accumulator storage circuit and combine the product in the product storage circuit with the accumulated value to produce a combined value in the accumulator storage circuit of each of the M time-shared multiply-accumulate circuits;
f) repeating steps c)-e) for each of the N bits of the first multi-bit value until all bits of the first multi-bit value are provided in bit order;
g) scaling the accumulated value of the time-shared multiply-accumulate circuit to produce a scaled value;
h) adding the scaled value to a multi-bit product; and
i) repeating steps c)-h) to produce a multi-bit product.

18. A hybrid matrix multiplier, comprising:
a time-shared multiply-accumulate circuit of claim 1;
a memory circuit for storing an accumulated value;
a control circuit operable to:
a) repeatedly and sequentially (i) provide a first input value and provide a second input value to the multiplier, set the accumulation switch to connect the product storage circuit to the multiplier and disconnect the product storage circuit from the accumulator storage circuit and (ii) switch the accumulation switch to electrically disconnect the product storage circuit from the time-shared multiply accumulate circuit and electrically connect the product storage circuit to the accumulator storage circuit to combine the product in the product storage circuit with the accumulated value and provide a combined value stored in in the accumulator storage circuit and the product storage circuit; and
b) store the accumulated value in a memory circuit.

19. The hybrid matrix multiplier of claim 18, comprising:
memory circuits, each memory circuit for storing an accumulated value; and
an adder for adding the accumulated values in the memory circuits,
wherein the control circuit is operable to provide different first input values and provide different second input values and store an accumulated value in each memory circuit.

20. A time-shared multiply-accumulate circuit, comprising:
a multiply circuit operable to receive a first input value, receive a second input value, and produce a product of the first input value and the second input value;
an accumulating digital storage circuit operable to store an accumulated digital value; and
a digital bit accumulator operable to receive the product, combine the product with the accumulated digital value stored in the accumulating digital storage circuit, and output the accumulated digital value,
wherein combining the product with the accumulated digital value comprises (i) storing a value in the accumulating digital storage circuit if the product is one and the accumulated digital value is zero, (ii) keeping the same accumulated digital value if the product is one and the accumulated digital value is non-zero, or (iii) or scaling the accumulated digital value by two if the product is zero.

21. The time-shared multiply-accumulate circuit of claim 20, comprising:
a product storage circuit operable to receive the product; and
a one-bit analog-to-digital converter connected to the product storage circuit and to the digital bit accumulator;
wherein the product storage circuit is operable to provide the product to the one-bit analog-to-digital converter and the one-bit analog-to-digital converter is operable to receive the product, convert the product to a digital bit product, and provide the digital bit product to the digital bit accumulator.
